(19) United States
(12) Patent Application Publication
(10) Pub. No.: US 2013/0318720 A1
(43) Pub. Date: Dec. 5, 2013

(54) PATIENT SUPPORT WITH IMPROVED PATIENT SAFETY

(71) Applicant: CHG Hospital Beds Inc., London (CA)

(72) Inventors: Jason Connell, London (CA); Richard Roussy, London (CA); Steven Bakker, St. Thomas (CA); Jason Cerny, London (CA); Christopher George, St. Thomas (CA)

(21) Appl. No.: 13/906,916

(22) Filed: May 31, 2013

Related U.S. Application Data
(60) Provisional application No. 61/654,803, filed on Jun. 1, 2012.

(51) Int. Cl. A61G 7/018; A61G 7/05

(52) U.S. Cl. CPC A61G 7/018; A61G 7/05; A61G 7/0526
USPC 5/611; 5/658; 5/425

(57) ABSTRACT

A patient support, such as a bed, can include a frame, a patient support deck coupled to the frame and configured to support a patient, and wheels coupled to the frame to support the patient support on a floor. A securing device can removably fasten the patient support to the floor. A guard structure coupled to the frame can include a substantially continuous body as well as a gripping portion for the patient and attendant. A controller can enable functionality of the patient support in response to an access control device being unlocked. A brake pedal can be removable from the patient support by an attendant. In another embodiment, the patient support can include a frame configured to be supported by the floor, a non-articulating patient support deck supported by the frame, side panels extending from the patient support deck to the floor, and restraint loops on opposite sides of the patient support deck.

### FIELD OF THE INVENTION

This disclosure relates to patient supports, such as hospital beds, and more specifically, patient supports with advanced safety features. More particularly, this disclosure relates to patient supports with advanced safety features for use in, for example, applications where the patient's mental condition is of concern, such as due to medications or in mental healthcare settings.

### BACKGROUND

Patient supports, such as beds, are known to have safety and lockout functionality. However, as patient supports become increasingly sophisticated and are used more often in demanding environments, such as mental health facilities, safety and lockout functionality is becoming increasingly important. Misuse or unauthorized use of a patient support may result in greater risks to the safety of the patient, the attendant or caregiver, and other individuals. Damage to the patient support or surrounding environment is also possible.

### SUMMARY OF THE INVENTION

A patient support according to this disclosure can include a frame, a patient support deck coupled to the frame and configured to support a patient, wheels coupled to the frame and positioned to movably support the frame on a floor.

According to one aspect of this disclosure, a securing device is coupled to the frame. The securing device is configured to releasably secure the patient support to a location suitable for immobilizing the patient support. For example, the securing device may be configured to removably fasten the frame to the floor, wall or other fixed object suitable for immobilizing the patient support.

According to another aspect of this disclosure, at least one guard structure is coupled to the frame. For example, two or four guard structures may be provided. Each of the guard structures has a substantially continuous body, preferably without any through-opening. Each of the guard structures has a gripping portion configured to be gripped by a person.

According to another aspect of this disclosure, a control panel is coupled to the frame and positioned to be accessed by an attendant. The control panel has a user interface, for example comprising buttons. A controller is coupled to the control panel and configured to control functionality of the patient support, for example movement functionality, comprising at least one of articulation of the patient support deck or height adjustment of A height-adjustable frame portion. The controller is configured to be locked out and only enable the functionality when an access control device is unlocked. The control panel may comprise the access control device. The access control device may be unlocked only by authorized users, for example in response to an authorization key being present, such as an authorization code that may be manually entered at the buttons of the control panel, a radio-frequency identification (RFID) tag, a biometric trait, a smart card, a magnetic key or a physical key.

According to another aspect of this disclosure, a brake mechanism is operably coupled to at least one of the wheels and a brake pedal is coupled to the brake mechanism and removable from the brake mechanism by an attendant.

Another patient support according to this disclosure can include a frame configured to be supported by a floor, a non-articulating patient support deck supported by the frame, at least two side panels extending from the patient support deck to the floor to enclose a space below the patient support deck, and restraint loops on opposite sides of the patient support deck.

### BRIEF DESCRIPTION OF THE DRAWINGS

The drawings illustrate, by way of example only, embodiments of the present disclosure.

FIG. 1 is a perspective view of a patient support.

FIG. 2 is a side view of the patient support of FIG. 1.

FIG. 3 is a functional block diagram of a system for controlling a patient support.

FIG. 4 is a side view of the patient support of FIG. 1 showing activation of a CPR mechanism.

FIG. 5 is a perspective view of an embodiment of the patient support showing features for improved patient safety.

FIG. 6 is a front view of a securing device.

FIG. 7 is a top rear view of the securing device disassembled.

FIG. 8 is a perspective view showing hidden components of a securing device according to another embodiment.

FIG. 9 is an exploded perspective view of a securing device according to another embodiment.

FIG. 10 is a perspective view of a side rail.

FIGS. 11a-b are diagrams of an attendant's control panel.

FIG. 12 is a flowchart of a method of entering numeric codes at the attendant's control panel.

FIG. 13 is a functional block diagram of a system for controlling the patient support with an access control device.

FIGS. 14a-d are perspective views of embodiments of different access control devices and authorization keys.

FIG. 15 is a perspective view of a removable brake pedal.

FIGS. 16a-b are perspective views of a flexible retainer for holding together panels of a patient support deck.

FIG. 17 is a perspective view of a mattress with a zipper-less cover.

FIG. 18 is an oblique projection of another embodiment of a patient support showing features for improved patient safety.

FIG. 19 is a detail at section A-A of FIG. 18 showing a flush joint.

FIG. 20 is a detail at section B-B of FIG. 18 showing a height-adjustable foot.

### DETAILED DESCRIPTION

As used herein, the term “patient support” refers to an apparatus for supporting a patient in an elevated position relative to a support surface for the apparatus, such as a floor. One embodiment of a patient support includes beds, for example hospital beds for use in supporting patients in a hospital environment. Other embodiments may be conceived by those skilled in the art. The exemplary term “hospital bed” or simply “bed” may be used interchangeably with “patient support” herein without limiting the generality of the disclosure.

As used herein, the term “guard structure” refers to an apparatus mountable to or integral with a patient support that prevents or interferes with egress of an occupant of the patient support from the patient support, particularly egress in an unintended manner. Guard structures are often movable to selectively permit egress of an occupant of the patient support and are usually located about the periphery of the bed, for example on a side of the bed. One embodiment of a guard structure includes side rails, mountable to a side of a patient support, such as a hospital bed. Another embodiment of a guard structure includes a head board or a foot board. Other embodiments may be conceived by those skilled in the art. The exemplary terms “guard rail”, “side rail”, or “rail structure” may be used interchangeably with “guard structure” herein without limiting the generality of the disclosure.

As used herein, the term “control circuit” refers to an analog or digital electronic circuit with inputs corresponding to a patient support status or sensed condition and outputs effective to cause changes in the patient support status or a patient support condition. For example, a control circuit may comprise an input comprising an actuator position sensor and an output effective to change actuator position. One embodiment of a control circuit may comprise a programmable digital controller, optionally comprising or interfaced with an electronic memory module and an input/output (I/O) interface. Other embodiments may be conceived by those skilled in the art. The exemplary terms “controller”, “control system”, “control structure” and the like may be used interchangeably with “control circuit” herein without limiting the generality of the disclosure.

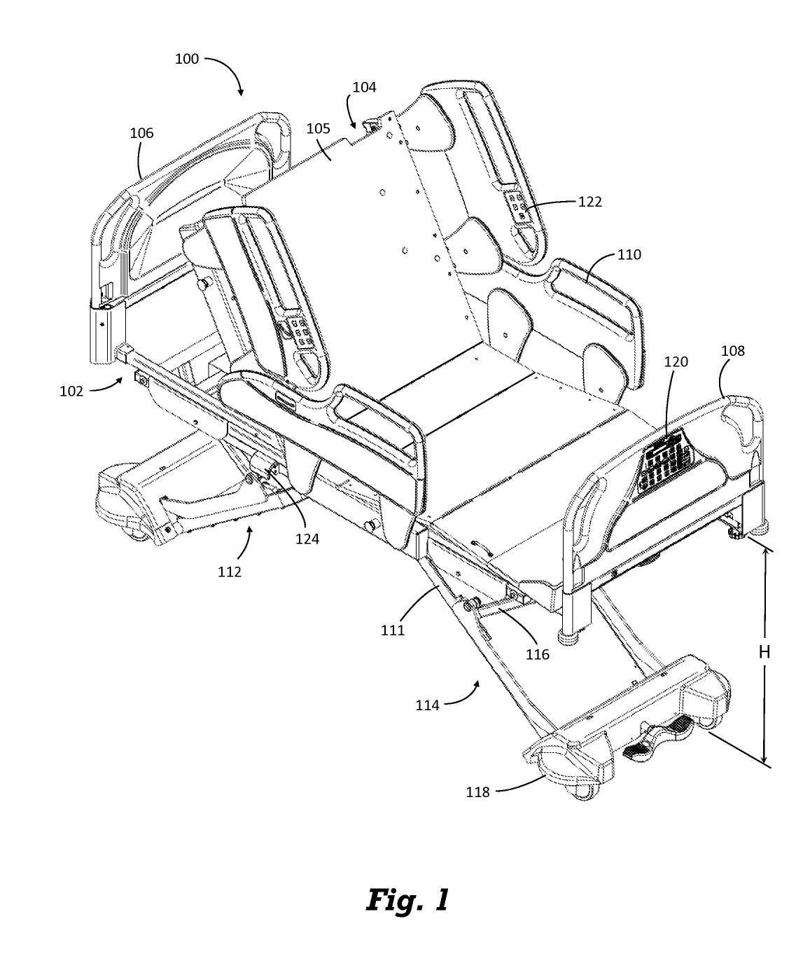

FIG. 1 illustrates an embodiment of a height-adjustable patient support 100. The patient support 100 includes a substantially horizontal frame 102 that supports an adjustable patient support deck 104 (or simply “deck”) positioned thereon to receive a patient support surface (or “mattress”) for supporting a patient thereon. For clarity, the mattress is not illustrated. The patient support deck 104 has an upper-body portion 105 capable of tilting up to form a backrest and tilting down to a prone position (tilt-up position shown). At the head end of the patient support 100 is a headboard 106, while a foot-board 108 is attached to the frame 102 at the foot end of the patient support 100. Guard structures comprising side rails 110 are positioned on each side of the patient support 100. Such side rails 110 may be moveable so as to facilitate entry and exit of a person. In this embodiment, the patient support 100 is a bed. The term “patient” is intended to refer to any person, such as a hospital patient, long-term care facility resident, or any other occupant of the patient support 100.

The patient support 100 includes two leg assemblies 112, 114, each having a pair of legs 111. The head leg assembly 112 is connected at the head end of the patient support 100 and the foot leg assembly 114 is connected at the foot end of the patient support 100. Upper portions of the legs 111 of the leg assemblies 112, 114 are connected to one or more linear actuators that may move the upper portions of the legs 111 back and forth along the length of the patient support 100. Leg braces 116 pivotably connected to the legs 111 and to the frame 102 constrain the actuator movement applied to the legs 111 to move the leg assemblies 112, 114 in a manner that raises and lowers the frame 102. In other words, the leg assemblies 112, 114 act as linkages that collapse and expand to respectively lower and raise the frame 102, whose height is indicated by H. The lower ends of the leg assemblies 112, 114 are connected to caster assemblies 118 that allow the patient support 100 to be moved to different locations.

Articulation of the patient support deck 104 is controlled by actuators (not shown) that adjust the tilt of the upper-body portion 105 of the patient support deck 104 as well as the height of a knee-supporting portion of the patient support deck 104.

A manual cardiopulmonary resuscitation (CPR) quick release handle 124 is provided on each side of the patient support 100 to rapidly lower the upper-body portion 105 of the patient support deck 104 and place the bed into an emergency state wherein the patient support deck 104 is flat and optionally the side rails are unlocked. This will be discussed in further detail below.

The patient support 100 further includes an attendant's control panel 120 located at the foot-board 108. The attendant's control panel 120 may, among other things, control the height H of the frame 102, as well as the articulation of the patient support deck 104. To allow for similar adjustment, an occupant's control panel 122 may be provided, for example, on a side rail 110.

The control panels 120, 122 include user interfaces, for example buttons. The buttons may be membrane style buttons that operate as momentary contact switches (also known as “hold-to-run” switches). Buttons may be provided to raise the frame 102, lower the frame, articulate the patient support deck 104, set/pause/reset an exit alarm, zero an occupant weight reading, lockout controls, and to enable other functions. The control panels 120, 122 may have different sets of buttons for different sets of functions, with the attendant's control panel 120 typically having a wider array of functions available. Other styles of user interface and buttons, such as touch-screen buttons, are also suitable. The user interfaces of the control panels 120, 122 may include indicators, such as printed graphics or graphics on a display, for describing the functions of the buttons or other interface and as well as indicating data related to the patient support 100.

It should be emphasized that the patient support 100 is merely one example of a patient support that may be used with the techniques described herein. Other examples of patient supports that may be so used include ultra-low type height-adjustable beds such as those disclosed in US Patent Publication No. 2011/113556 and U.S. Pat. No. 7,003,828, which are both incorporated herein by reference.

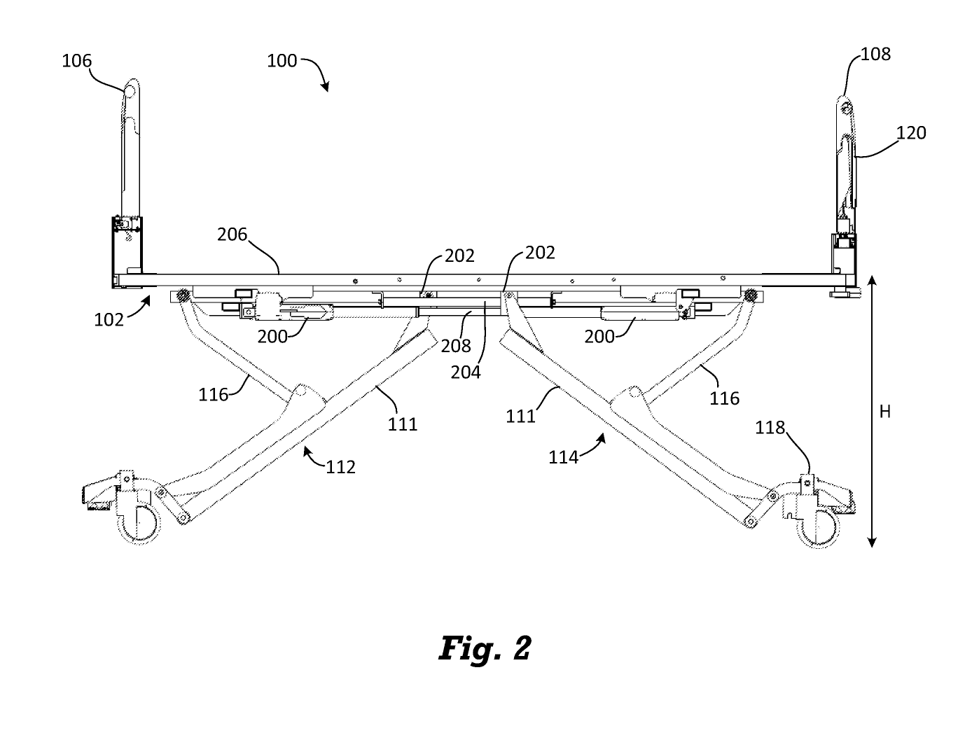

As shown in FIG. 2, one or more linear actuators 200 are provided to the leg assemblies 112, 114. Each linear actuator 200 has an extendable/retractable rod 208 that is connected to a bearing block 202, which slidably engages with a respective guide rod 204. The guide rods 204 are fixed to the frame 102. The upper portions of the legs 111 of each of the leg assemblies 112, 114 are pivotably connected to the respective bearing block 202. When the actuators 200 extend and retract, the bearing blocks 202 move linearly along the lengths the guide rods 204. This linear motion is converted, via the additional constraint of the pivot-connected leg braces 116, to motion that raises and lowers the frame 102. Also illustrated is one of the elongate structural members 206 that, together with cross-members (not shown), form the frame 102. Although in this embodiment the patient support 100 has two actuators 200 for raising and lowering the frame 102, it should be understood that one or more actuators 200 may be used.

Each actuator 200 may include an actuator position sensor that may output a signal indicative of the position of the actuator 200 and thus the height of the frame 102 above the floor. For instance, the actuator position sensor may be a digital rotary encoder that outputs pulses to a control circuit that may comprise a programmable digital controller, which may count the pulses to determine the position of the bearing block 202 and may further lookup or calculate a height of the frame 102 based on this count. A single actuator position sensor may be indicative of frame height when more than one actuator 200 is used. In other examples, other kinds of position or height sensors may be used and these need not be included in the actuator.

The actuators 200 may also be configured to move the patient support 100 into other positions, such as the Trendelenburg position (head lower than foot) or the reverse Trendelenburg position (head higher than foot).

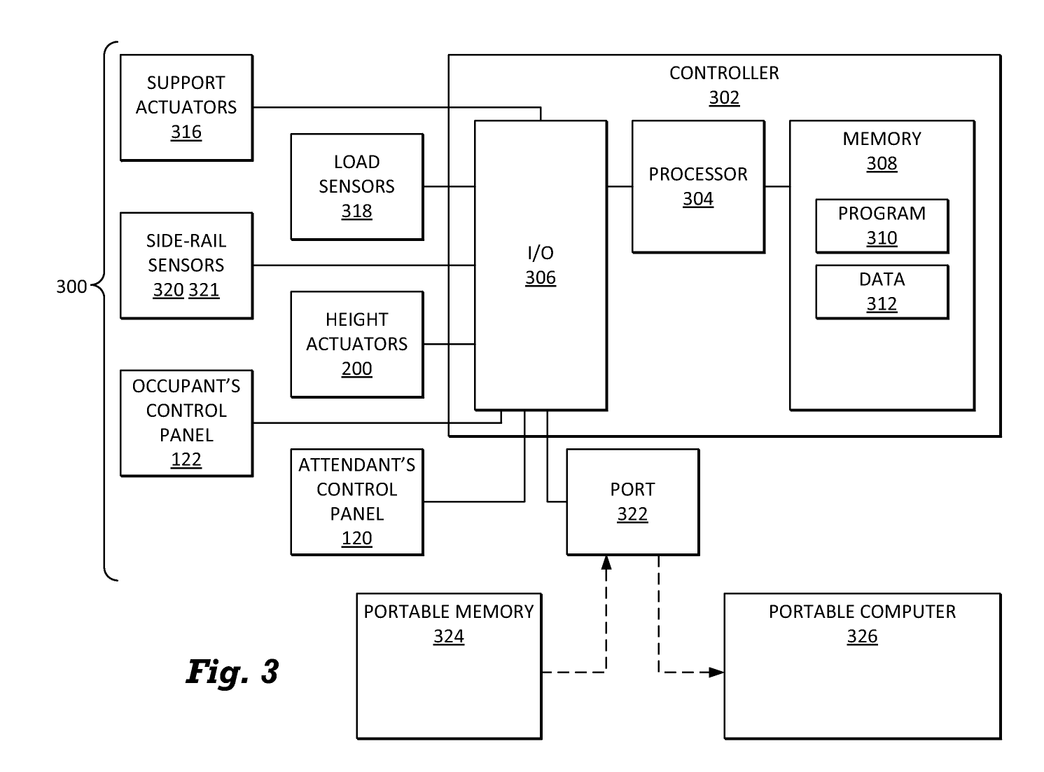

FIG. 3 shows a block diagram of a system 300 for controlling the patient support 100. Each of the components of the system 300 may be attached to the patient support 100 at a suitable location.

The system 300 includes a controller 302 that includes a processor 304 electrically coupled to an input/output interface 306 and memory 308. The controller 302 may be situated in a control box that is attached or otherwise coupled to the patient support 100. The controller 302 may be physically integrated with another component of the system 300, such as the attendant's control panel 120.

The processor 304 may be a microprocessor, such as the kind commercially available from Freescale™ Semiconductor. The processor 304 may be a single processor or a group of processors that cooperate. The processor 304 may be a multicore processor. The processor 304 is capable of executing instructions obtained from the memory 308 and communicating with the input/output interface 306.

The memory 308 may include one or more of flash memory, dynamic random-access memory, read-only memory, and the like. In addition, the memory 308 may include a hard drive. The memory 308 is capable of storing data and instructions for the processor 304. Examples of instructions include compiled program code, such as a binary executable, that is directly executable by the processor 304 and interpreted program code, such as Java® bytecode, that is compiled by the processor 304 into directly executable instructions. Instructions may take the form programmatic entities such as programs, routines, subroutines, classes, objects, modules, and the like, and such entities will be referred to herein as programs, for the sake of simplicity. The memory 308 may retain at least some of the instructions stored therein without power.

The memory 308 stores a program 310 executable by the processor 304 to control operations of the patient support 100. The controller 302 comprising the processor 304 executing the program 310, which configures the processor 304 to perform actions described with reference to the program 310 may control, for example, the height of the frame 102, articulation of the patient support deck 104 (e.g., upper-body tilt and knee height), exit alarm settings, and the like. The controller 302 may also be configured to obtain operational data from the patient support 100. Operational data obtained by the controller 302 may be used by the processor 304 and program 310 to determine control limits for the patient support 100.

The memory 308 also stores data 312 accessible by the processor 304. The data 312 may include data related to the execution of the program 310, such as temporary working data. The data 312 may additionally or alternatively include data related to properties of the patient support 100, such as a patient support serial number, model number, MAC address, IP address, feature set, current configuration, and the like. The data 312 may additionally or alternatively include operational data obtained from components, such as sensors and actuators, of the patient support 100. Operational data may include the height of the frame 102, an articulated state of the patient support deck 104, a status of the side rails 110, an exit alarm setting or status, and/or an occupant weight. The data 312 may include historic data, which may be time-stamped. For example, the occupant's weight may be recorded several times a day in association with a timestamp. The data 312 may be stored in variables, data structures, files, data tables, databases, or the like. Any or all of the data mentioned above may be considered as being related to the patient support 100.

The input/output interface 306 is configured to communicate information between the processor 304 and components of the system 300 outside the controller 302. The communication may be in the form of a discrete signal, an analog signal, a serial communication signal, or the like. The input/output interface 306 may include one or more analog-to-digital converters.

In one embodiment, the input/output interface 306 allows the processor 304 to send control signals to the other components of the system 300 and to receive data signals from these components in what may be known as a master-slave arrangement.

The system 300 may further include components, such as one or more actuators 316 configured to control the articulation of the patient support deck 104, one or more load sensors 318 (e.g., load cells) positioned to measure the weight of the occupant of the patient support 100, one or more side-rail sensors 320, 321 configured to sense the position and/or locked state of a side rail 110, the frame-height actuators 200, the occupant's control panel 122, and the attendant's control panel 120. Each of the components may receive control signals from the controller 302, send data signals to the controller 302, or both.

In this embodiment, the controller 302 includes the input/output interface 306 having one or more physical ports 322, such as a universal serial bus (USB) port, a memory card slot, an Ethernet jack, a serial port, or the like. The port 322 includes logic, such as a USB controller or Ethernet adaptor, to allow transfer of data between the controller 302 and a physically connected external device, such as a memory stick, memory card, portable computer, or similar device. Such physical connections may be made by an appropriate cable, such as a USB cable, Ethernet crossover cable, or the like. When the port includes a network interface, standard network protocols may be used. The port 322 accepts a physical connection (e.g., a cable or insertion of a card).

A portable memory device 324, such as a USB memory stick or flash memory card, or an external computer, such as a portable computer 326, may be connected to the port 322 to communicate data with the patient support 100.

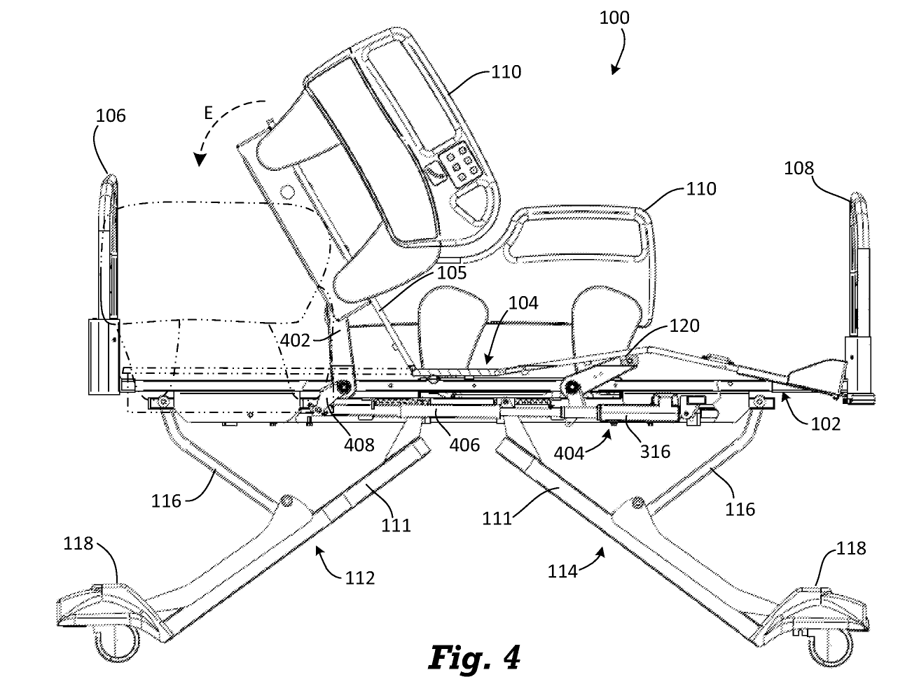

As mentioned, the upper-body portion or backrest 105 of the patient support deck 104 is variably positionable, and accordingly may be raised and lowered so that the occupant of the patient support 100 may be provided with, for example, a range of positions between fully prone and sitting upright. As shown in FIG. 4, a backrest support 402 is pivotably connected to the frame 102 and supports the backrest 105 over its range of positions.

A backrest actuator assembly 404 is connected between the backrest 105 and the frame 102 and is configured to raise and lower the backrest 105 with respect to the frame 102. In this example, the backrest actuator assembly 404 includes an actuator 316, which is connected to the frame 102. The backrest actuator assembly 404 may further include an emergency mechanism that may be activated in the event of an emergency condition, such as the need to perform cardiopulmonary resuscitation (CPR) on a patient. The backreset actuator assembly 404 comprising an emergency mechanism further includes a lockable damper 406 that is connected in series with the actuator 316 at one end and is pivotably connected to a lever arm 408 extending from the backrest support 402 at another end. The lever arm 408 may also be known as a head gatch bracket. The CPR handle 124 operates with the above components to release or lower the backrest 105 in the event of an emergency.

The actuator 316 may be an electric motor-driven linear actuator.

The lockable damper 406 may be a lockable fluid-filled damper, such as a locking hydraulic damper, locking gas spring, or the like. The lockable damper 406 is configured to provide damping over a range of motion when unlocked and configured to rigidly or nearly rigidly lock at any position on the range of motion. For the linear style damper described herein, range of motion may be known as damper stroke. Dampers may also be known as dampeners or dashpots.

In one example, the lockable damper 406 includes a cylindrical body though which a piston slides. Each side of the piston has a chamber of fluid that is selectively communicated by pushing an unlocking pin that opens a valve in the piston to allow fluid to move between the chambers. Relative movement between the cylindrical body and a rod extending from the piston may then be damped (valve open) or held rigid (valve closed). In other examples, other kinds of dampers may be used. The lockable damper 406 may be a BLOC-O-LIFT™ device sold by Stabilus GmbH of Koblenz, Germany.

Each CPR handle 124 (see FIG. 1) is connected to the lockable damper 406. Each CPR handle 124 is configured to unlock the lockable damper 406 when actuated to an unlock position, thereby allowing the damper 406 to contract without having to operate the actuator 316.

During normal operation of the patient support 100, the lockable damper 406 is locked in an extended state and movement of the actuator 316 causes the lockable damper 406 to push or pull against the lever arm 408 to raise or lower the backrest 105 as commanded by the controller 302 operated by the bed's occupant or an attendant, such as a nurse or caregiver.

During an emergency, such as a cardiac arrest of the bed's occupant, a CPR handle 124 may be manually actuated to quickly allow the backrest 105 to lower due to gravity as shown by arrow E (lowered position shown in phantom line). The rate of lowering of the backrest 105 is controlled at least in part by the damping effect of the damper 406 as it contracts over its damped range of motion under the weight of the backrest 105, backrest support 402, attached side rails 110, mattress, the occupant's upper body, and any other items in or on the patient support 100.

After the CPR handle 124 has been actuated and while the backrest 105 is lowering due to gravity, the CPR handle 124 may be returned to its original position, or lock position, to lock the lockable damper 406 at its current length and thereby stop the lowering of the backrest 105. The backrest 105 may be stopped at any position along the damped range of motion, which may make for safer bed operation. For example, if the arm of the occupant or that of a person standing near the hospital bed is under the backrest 105 during a CPR release, the backrest 105 may be temporarily stopped to reduce the chance of injury.

Once the CPR handle 124 is pulled and the emergency mechanism is activated to place the patient support in an emergency state, the goal is to allow caregiver's to perform whatever procedures are required to attend to the immediate needs of the patient. Accordingly, a patient supporting surface of the patient support is made flat when in the emergency state and, optionally, the side rails are unlocked through actuation of the release, permitting them to drop out of the way due to gravity. Other actions may also be performed automatically by the patient support when the emergency mechanism is activated to improve access of the caregiver to the patient or otherwise facilitate emergency care.

As will now be discussed, the patient support 100 includes one or more features for improved safety in a healthcare environment, for example a mental healthcare setting. These environments often require advanced protective measures to reduce the chance of patient self-harm, harm to others (e.g., attendants, caregivers, visitors, etc.), and damage to facilities or the patient support 100 itself.

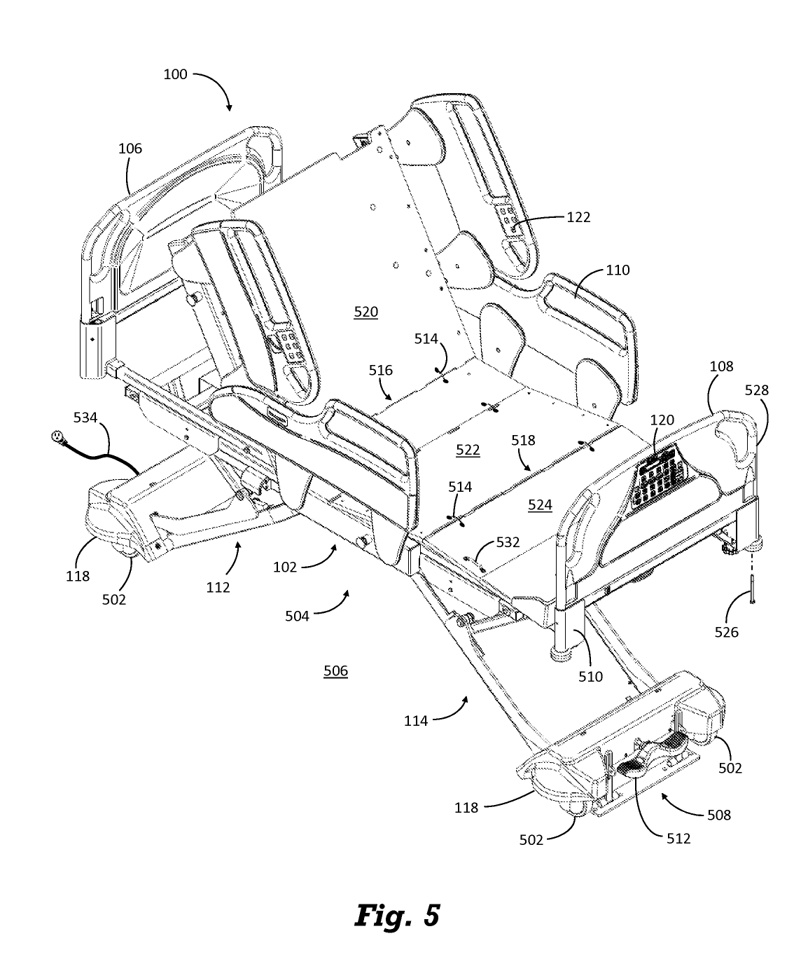

Referring to FIG. 5, each of the two caster assemblies 118 of the patient support 100 includes two caster wheels 502. The caster wheels 502 can be considered to be coupled to the frame 102 and, more specifically, to a height-adjustable portion of the frame that includes the leg assembles 112, 114. Although shown coupled to the lower ends of the legs 112, 114, the caster wheels 502 may be connected to another part of the frame 102 that allows the patient supported to be supported by the floor. For example, a lower frame, or base frame, may be provided to which the caster wheels 502 are coupled and to which the height adjustable portion of the frame is also coupled. This still constitutes a frame 102 having a height adjustable portion, or simply a height adjustable frame 504, as described herein. The caster wheels 502 are positioned to movably support the height-adjustable frame 504 on the floor 506.

A pair of securing devices 508 are coupled to the height-adjustable frame 504 and configured to releasably secure the patient support 100 to a location suitable for immobilizing the bed. In particular, the securing devices 508 are configured to removably fasten the patient support 100 to the floor 506. In this embodiment, two securing devices 508 (one hidden from view in FIG. 5) are positioned at opposite ends of the height-adjustable frame 504, with each securing device 508 being removably fastened to one of the caster assemblies 118. Each securing device 508 is positioned within the perimeter of the patient support 100 to reduce a tripping hazard.

The securing devices 508 being removable from the patient support 100 advantageously allows the patient support 100 to be rolled to another location, while still permitting the patient support 100 to be securely fastened to the floor 506 when needed, such as when used by a patient who suffers from a mental health problem and who therefore may be inclined to move the patient support 100 or use it to cause damage or injury. Providing a securing device 508 at each end of the patient support 100 beneficially reduces the chance that the patient support 100 can be turned or rocked to free the patient support 100 from the floor 506 or have an unsecured end lifted, as is more readily possible if only one securing device were to be used.

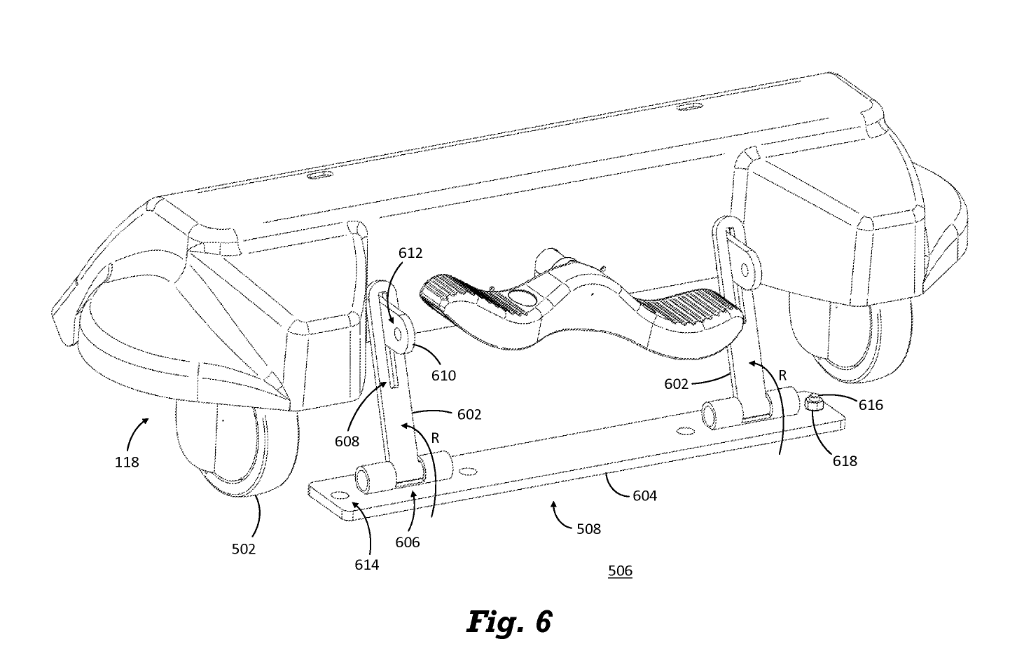

Referring to FIG. 6, in this embodiment, each securing device 508 comprises at least one connecting member 602 and a base 604 from which the connecting member 602 extends. In this embodiment, two connecting members 602 are used. Each connecting member 602 has one end, at a hinge 606, that is connected to the base 604, which is attached to the floor 506. Each connecting member 602 has another end having an elongate slot 608 that allows the connecting member 602 to be removably fastened to the caster assembly 118.

Each hinge 606 pivotably connects the lower end of the respective connecting member 602 to the base 604. The hinge 606 is also configured to allow removal of the connecting member 602 from the base 604 without the use of tools, as will be discussed below.

At the upper end of the connecting member 602, the slot 608 mates with a lug 610 that extends from the caster assembly 118 of the patient support 100. A padlock, bolt, pin, or similar apparatus can be inserted into a hole 612 in the lug 610 to block disconnection of the connecting member 602 from the lug 610. In this way the securing device 508 is removably fastenable to the lug 610, and thus releasably secures the patient support 100 to the floor 506.

Holes 614 in the base 604 allow the base 604 to be fixed to the floor 506. In this embodiment, four holes 614 are spaced along the length of the base 604. Threaded stud anchors 616 (one shown) can be embedded in the floor 506 at locations corresponding to the holes 614 in the base 604. Nuts 618 (one shown) can then be threaded onto the stud anchors 616 to fasten the base 604 to the floor 506. Other fastening techniques can alternatively be used to secure the base 604 to the floor 506.

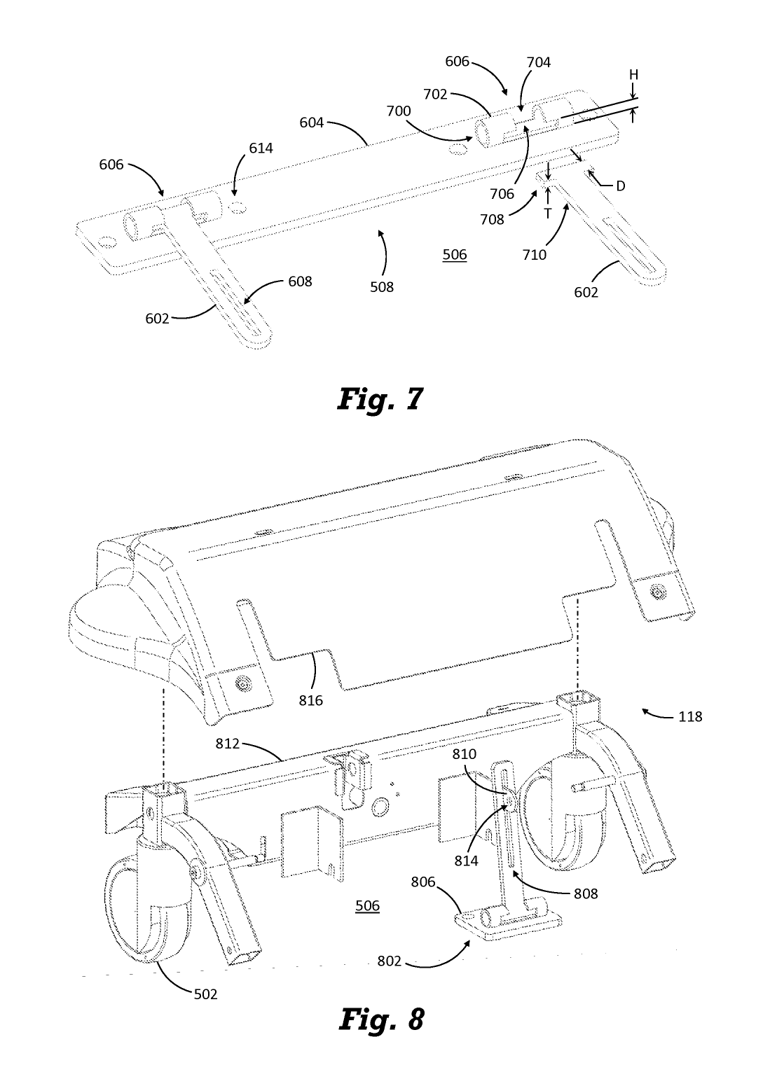

With reference to FIG. 7, the hinges 606 are shown in more detail. The hinges 606 are the same. In the figure, for illustrative purposes, the left hinge 606 has the respective connecting member 602 inserted, while the right hinge 606 has the respective connecting member 602 removed.

Each hinge 606 includes a hollow tubular body 702 having a circular cross-section through which a circular bore 700 extends. At the midpoint of the tubular body 702 are located a narrow opening 704 and a wider opening 706. The wider opening 706 is oriented to receive insertion of the connecting member 602 when the connecting member 602 is about parallel to the floor 506 or the plane of the base 604. The narrow opening 704 is sized to permit rotation of the connecting member 602 through a selected angular range, which in this embodiment is about 180 degrees.

Each connecting member 602 includes a wide portion 708 at the end that mates with the hinge 606. The wide portion 708 is wider than the remaining portion 710 of the connecting member 602. The shape and size of wide portion 708 is selected to fit through the wider opening in the hinge 706 but not through the narrow opening 704. The wide portion 708 of the connecting member 702 has a rectangular cross-section having a depth D that is larger than the height H of the wider opening 706 but smaller than the diameter of the bore 700 of the tubular body 702. On the other hand, a thickness T of the wide portion 708 is small enough to clear the height H of the wider opening 706. Thus, the wide portion 708 of the connecting member 702 can be inserted into the hollow tubular body 702 in one pivotal orientation of the connecting member 702 (depicted), but is restrained in other orientations (e.g., the orientation shown in FIG. 6).

The connecting members 602 are thus installable and removable from the base 604 without the use of tools, while still being able to pivot in hinges 606 to provide rotation and some mechanical play for assembly. This advantageously allows the connecting members 602 to be easily removed from the base 604 when the patient support 100 is moved to another location. Thus, since only the base 604 remains fixed to the floor when no patient support 100 is present, the danger of tripping or injury is reduced.

In use, referring again to FIG. 6, multiple bases 604 are fastened to the floor 506 at various locations where the patient support 100 is desired to be used in a securely fixed manner. Such locations can include, for example, various rooms at a healthcare facility. When securing the patient support 100, the connecting members 602 are connected to the bases 604 and laid in the floor 506 at a particular location where the patient support 100 is to be used. The patient support 100 is then positioned between and aligned with the bases 604. The connecting members 602 are then rotated upwards towards the caster assembly 118, so that the slots 608 in the connecting members 602 fit over the lugs 610. Padlocks or other apparatuses are then installed in the holes 612 in the lugs 610 to prevent the connecting members 602 from being disconnected.

In addition, the slots 608 of the connecting members 602 are longer than the size of the lugs 610 and the hinges allow rotation of the connecting members, both of which can accommodate movement or rotation of the caster assembly 118 while the patient support 100 is being raised and lowered. Such movement or rotation may be due to the structure of the particular leg assemblies 112, 114 used or may be due to specific actuated positions of the patient support 100, such as the Trendelenburg or reverse Trendelenburg positions.

Regarding manufacture, the connecting members 602, lugs 610, and base 604 can be made of metal plate or bar stock cut to shape. Each hinge 606 can be made of one or more pieces of metal tube welded to the base 604. The lugs 610 can be welded to the caster assembly 118.

FIG. 8 shows a securing device 802 according to another embodiment. The securing device 802 is similar to the securing device 508. Features and aspects of the securing device 802 can be used with the securing devices of the other embodiments described herein and vice versa.

The securing device 802 is removably connected to the castor assembly 118. The securing device 802 includes a connecting member 804 that is hinged to a base 806, which is fixed to the floor 506. The connecting member 804 includes an elongate slot 808 that mates with a lug 810 that is fixed to a cross-member 812 of the caster assembly 118. A padlock or other apparatus can be inserted into a hole 814 in the lug 810 to fasten the connecting member 804 to the lug 810. In this embodiment, one such securing device 802 is used at each castor assembly 118.

The securing device 802 is positioned under a portion of the caster assembly 118, and specifically, positioned under a cover 816 of the caster assembly 118, so as to be concealed by the cover 816. The cover 816 conceals structural components of the caster assembly 118 as well as the securing device 802 in order to reduce the chance of damage or injury due to exposed metal parts, such as the connecting member 804. In addition, concealing the securing device 802 in this manner advantageously reduces the chance of tampering by patients or other unauthorized individuals.

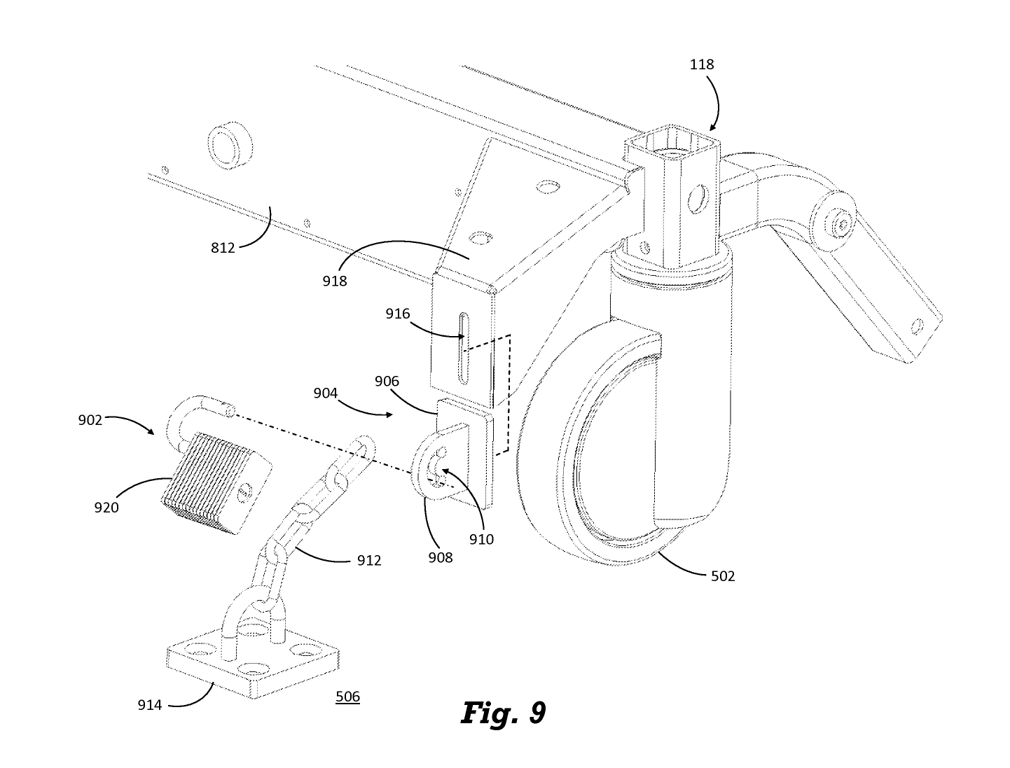

FIG. 9 shows a securing device 902 according to another embodiment. Features and aspects of the securing device 902 can be used with the securing devices of the other embodiments described herein and vice versa.

The securing device 902 includes a removable lug 904 that has a backing plate 906 and a flange 908 extending perpendicularly from the backing plate 906. The flange 908 includes a slot 910 for connecting to an upper link of a chain 912, which is a connecting member that forms part of the securing device 902. The slot 910 have an arcuate shape. The securing device 902 further includes a base 914 that is fixed to the floor 506. A lower link of the chain 912 connects to a link of the base 914. The flange 908 of the removable lug 904 is inserted through a like-shaped slot 916 in a generally hollow bumper bracket 918 that extends from the cross-member 812 of the caster assembly 118. The backing plate 906 prevents the removable lug 904 from leaving the slot 916 forwardly and a padlock 920 or similar apparatus connecting the upper link of the chain 912 to the slot 910 of the lug 904 prevents the lug 904 from leaving the slot 916 rearwardly (into the bumper bracket 918). The chain 912 secured in this manner thus secures the patient support 100 to the floor 506.

In this embodiment, when the securing device 902 is not being used, the padlock 920 and removable lug 904 can be removed and stored, leaving the chain 914 fixed to the floor 506. However, if desired, another padlock or similar apparatus can be used to connect the lower link of the chain 912 to the link on the base 914, so that the chain 912 can also be removed and stored.

In this embodiment, the securing device 902 is located at a lower corner of the patient support 100 near one of the caster wheels 502. Any number, e.g., one to four, of such securing devices 902 may be used to at different locations to secure the patient support 100 to the floor 506.

The securing devices discussed above prevent the patient support 100 from being moved by unauthorized people, such as patients and especially when the patient's mental condition is of concern. The securing devices thus advantageously reduce the risk of personal harm and property damage.

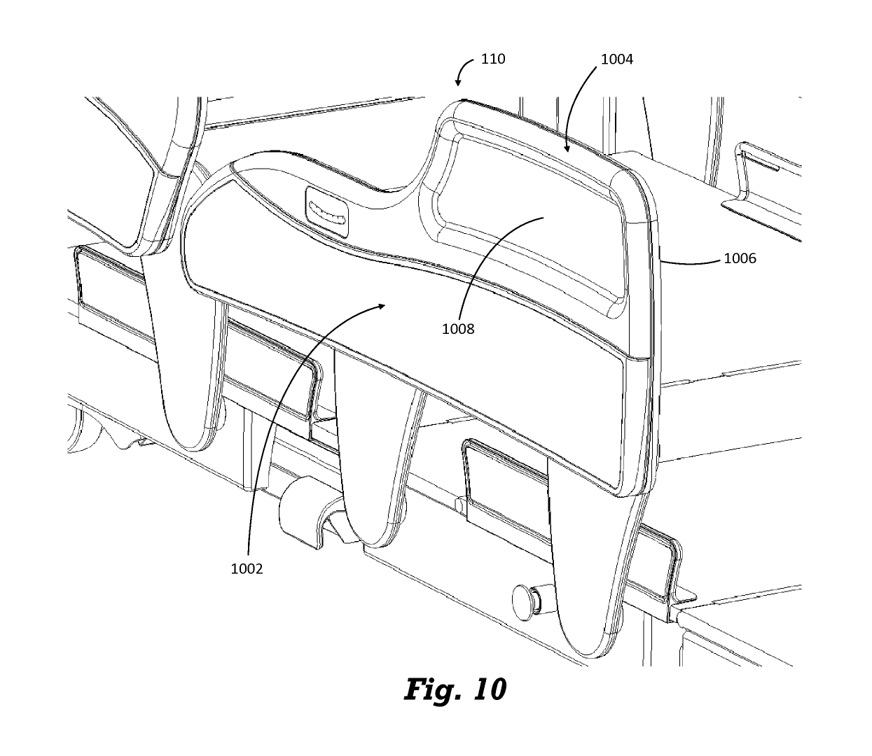

Referring to FIG. 10, one of the side rails 110 is shown. The side rail 110 is an example of a guard structure. Any or all of the side rails 110, headboard 106, and footboard 108 can be considered guard structures and can have the features described below for the side rail 110.

The side rail 110 has a continuous body 1002 without any through-openings of significant size, as such openings may be used by a patient to cause harm to themselves. Examples of through-openings of significant size are those large enough to fit a finger, arm, or other body part. Still other examples include openings large enough to allow tying of shoelaces or similar objects that may pose a risk of strangulation. In addition, since the side rails 110 can be lowered, through-openings would also pose an entrapment hazard with the mattress or patient support deck 104. Thus, the lack of through-openings of significant size increases patient safety.

The side rail 110 has a gripping portion 1004 configured to be gripped by a person, for example the patient or an attendant. The gripping portion 1004 has a thickened portion 1006 positioned at an outside edge of the side rail 110 and a thinner interior portion 1008 located adjacent the thickened portion 1006. The thickened portion 1006 and adjacent thinner portion 1008 allow for gripping by the hand of a patient when adjusting his/her position in the patient support 100, for controlling the side rail or for handling of the patient support 100 by an attendant or caregiver, while precluding a need for through-openings that may cause safety concerns.

The side rail 110 may comprise an antimicrobial material, such as a coating or embedded material that kills microbes and improves patient safety by reducing the risk of infection.

In this embodiment, each of the side rails 110, headboard 106, and footboard 108 has a continuous body without any through-opening of significant size and a thickened portion with adjacent thinner portion for gripping or handling, as described above.

Referring to FIG. 5, the attendant's control panel 120 is positioned on the footboard 108 to be accessed by an attendant or caregiver and the occupant's control panel 122 is positioned on a side rail 110 for access by the patient. When the patient's mental condition is of concern, it is advantageous that only authorized users, for example attendants or caregivers, have access to the functionality of the bed. This may be provided, for example, by an access control device coupled to the controller 302. The access control device is configured to be unlocked by an authorized user in order to enable bed functionality. The access control device may be configured to be selectively locked by an authorized user or configured to remain in a normally locked state to prevent unauthorized access to bed functionality. This prevents patients from readily accessing bed functionality, especially movement controls, and possibly controlling the patient support 100 in a way that may hurt themselves or others, thereby improving patient safety. The combination of the controller 302 and the access control device may be known as a security lockout or “psych” lockout. In this context, “bed functionality” may include any functions of the controller 302, for example bed movement controls, such as bed height and patient support deck articulation, alarms, such as bed exit alarms, patient weight information, data connectivity, guard structure locking state, etc. The control panel may comprise the access control device or it may be separate from the control panel and electrically coupled to the controller 302.

With reference to FIG. 3, the controller 302 is configured to control functionality of the patient support 100, for examplearticulation of the patient support deck 104 or height adjustment of the height-adjustable frame 504. The controller 302 is further configured to temporarily enable such movement functionality when an access control device is unlocked by authorized users, for example in response to an authorization key being present and provided to the access control device. Examples of suitable authorization keys include a radio-frequency identification (RFID) tag, a magnetic key, a physical key or an authorization code that may be manually entered at the buttons of the attendant's control panel 120. The controller 302 can be so configured by the processor 304 executing the program 310.

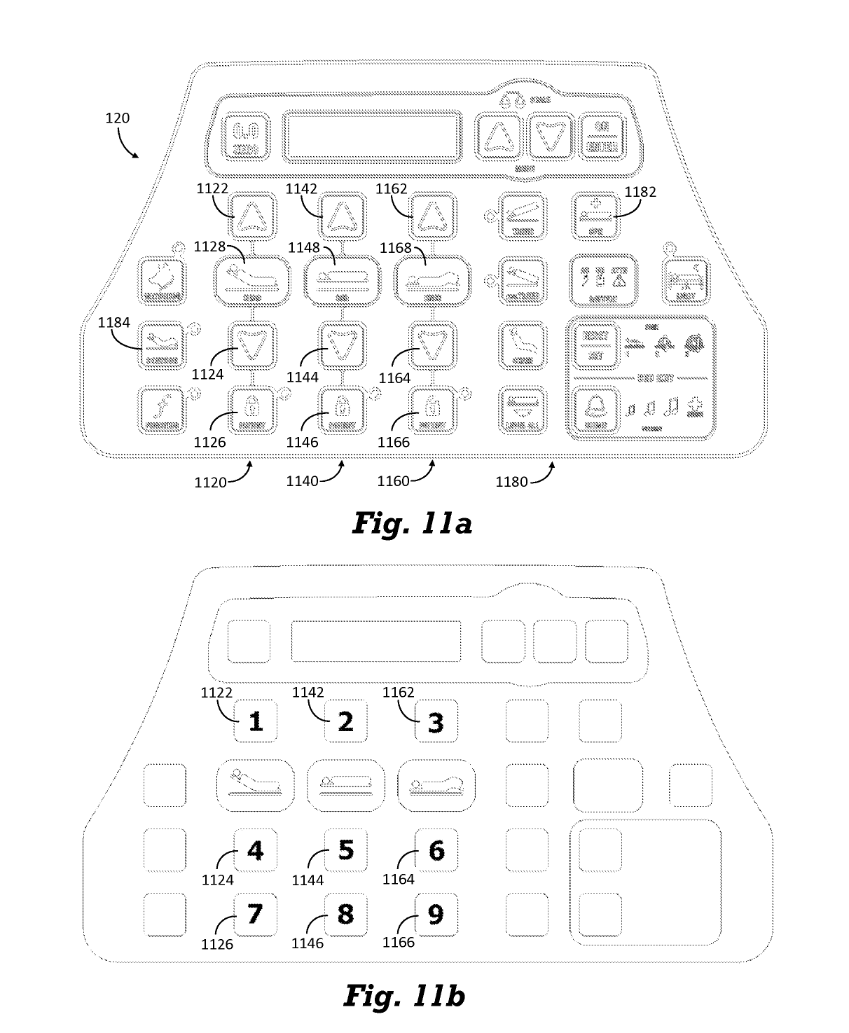

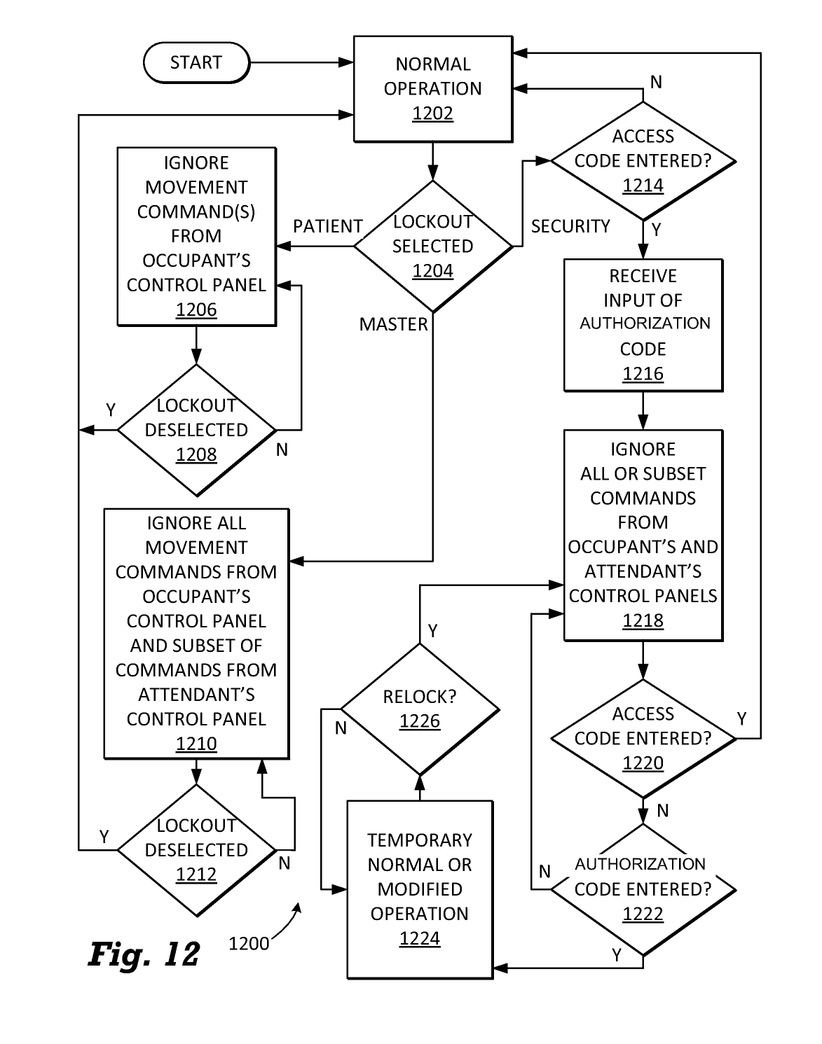

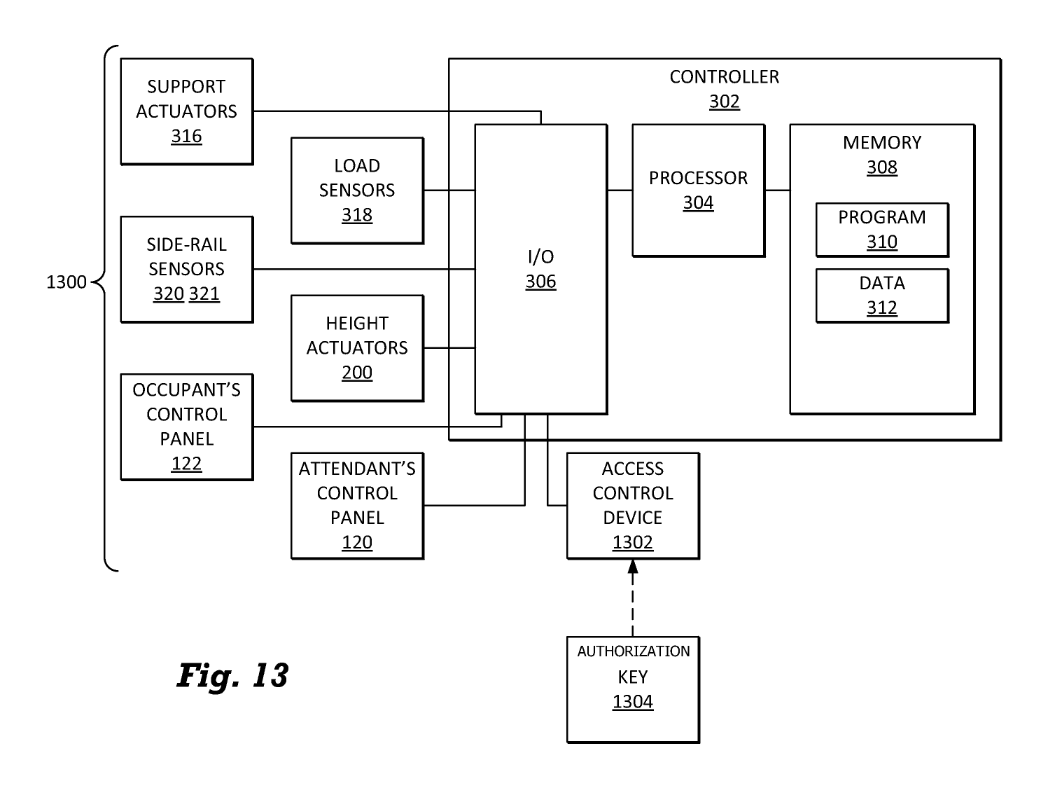

FIG. 13, shows an embodiment of a system 1300 for controlling the patient support 100. The system 1300 can be used in conjunction with the security lockout feature described with reference to FIGS. 11-12. The system 1300 is similar to the system 300 of FIG. 3, and the description of the system 300 can be referenced generally, and can be referenced specifically for elements having like reference numerals.

The system 1300 includes an access control device 1302 that is electrically coupled to the controller 302, and specifically, electrically coupled to the processor 304 via the input/output interface 306. The access control device 1302 can be unlocked by an authorization key 1304, such as an authorization code, a radio-frequency identification (RFID) tag, biometric trait, a smart card, a magnetic key or physical key, which can be provided by an authorized user, such as an attendant or caregiver. The access control device 1302 can be located at any suitable location on or near the patient support, with wired or wireless connectivity to the controller 302. The control panel 120 may comprise the access control device 1302.

FIG. 11a shows the attendant's control panel 120 according to one embodiment of the system 1300, with buttons for use in controlling functionality of the patient support by entry of an authorization key 1304 in the form of an authorization code. A first group of buttons 1120 controls articulation of the upper-body portion 105 of the patient support deck 104. A second group of buttons 1140 controls the height of the frame 102. A third groups of buttons 1160 controls articulation of the knee-supporting portion of the patient support deck 104. A set of other buttons 1180 are provided to control other features of the patient support 100, such as lighting, alarms, preprogrammed positions for the patient support deck 104, and an electronic CPR function, via a CPR button 1182, that causes the controller 302 to quickly articulate the patient support deck 104 to a flat position so that emergency CPR can be performed. In addition, a contour button 1184 can be provided to control a contour function of the patient support 100.

The buttons 1120 for controlling upper-body position include an upper-body raise button 1122, an upper-body lower button 1124, and an upper-body lock button 1126 that locks out control of upper-body movement at the occupant's control panel 122. An upper-body articulation indication 1128 (e.g., a diagram) is provided between the buttons 1122, 1124 to indicate to the attendant or caregiver the functions of the buttons 1122, 1124, 1126. Alternative or additional indications, such as the text “HEAD”, can also be provided.

The buttons 1140 for controlling the height of the frame 102 include a frame raise button 1142, a frame lower button 1144, and a frame height lock button 1146 that locks out control of frame-height movement at the occupant's control panel 122. A frame height articulation indication 1148 (e.g., a diagram) is provided between the buttons 1142, 1144 to indicate to the attendant or caregiver the functions of the buttons 1142, 1144, 1146. Alternative or additional indications, such as the text “BED”, can also be provided.

The buttons 1160 for controlling lower-body position include a lower-body raise button 1162, a lower-body lower button 1164, and a lower-body lock button 1166 that locks out control of lower-body movement at the occupant's control panel 122. A lower-body articulation indication 1168 (e.g., a diagram) is provided between the buttons 1162, 1164 to indicate to the attendant or caregiver the functions of the buttons 1162, 1164, 1166. Alternative or additional indications, such as the text “KNEE”, can also be provided.

FIG. 11b illustrates a conceptual numeric mapping for the buttons 1122-1166 so that the pattern corresponding to the authorization code can be more easily remembered and manually entered at the buttons 1122-1166.

The buttons 1122-1166 are mapped to the digits “1” to “9” and, in this embodiment, the physical arrangement of the mapping conforms to a common telephone keypad layout (omitting “0”, “*”, and “#”). The authorization code may thus be thought of as numeric and can include any series of digits from “1” to “9”. The program 310 of the controller 302 is provided with this mapping, stored as data 312 for example, so that when the authorization code is to be entered, the controller 302 treats input at the buttons 1122-1166 as digits “1” through “9” instead of the normal movement or locking commands. For example, a press of the button 1162 is detected at the controller 302 as input of a “3”, a press of button 1144 is detected as input of a “5”, and so on. However, the buttons 1122-1166 do not have visible indications of the digits “1” through “9”. Instead, the arrangement of the buttons 1122-1166 and the numeric mapping to a common telephone keypad layout allows those people knowledgeable of enterable numeric codes to enter such codes easily and intuitively without giving unauthorized people (e.g., patients) any indication that a numeric code can be entered via the buttons 1122-1166. Lack of numeric indications on the buttons 1122-1166 advantageously deprives unauthorized individuals the opportunity to guess the authorization code, and may prevent unauthorized individuals from even becoming aware that an authorization code exists.

FIG. 12 is a flowchart of a method 1200 that shows how codes can be entered at the buttons 1122-1166 to enable or disable patient, master and security lockouts. The method 1200 may be used with one embodiment of the system 1300 and can form part of the program 310. Authorization codes and/or access codes can be stored as data 312 in the memory 308 (FIG. 3).

At 1202, the patient support 100 is operated normally. All functions are available at both the attendant's control panel 120 and the occupant's control panel 122. That is, the controller 302 (FIG. 3) responds to all commands to raise and lower the frame and articulate the patient support deck 104, whether such commands are received from the attendant's control panel 120 or the occupant's control panel 122. This mode is suitable when control by the patient is permitted.

At 1204, a control lockout can be selected. If no lockout is selected, normal operation at 1202 continues. In this embodiment, the choice of lockouts includes a patient lockout, a master lockout, and a security lockout. The type of lockout selected can be determined by preconfigured inputs at the attendant's control panel 120. For example, pressing one of the lock buttons 1126, 1146, 1166 (FIG. 11a) initiates a respective patient lockout, pressing all three lock buttons 1126, 1146, 1166 simultaneously initiates the master lockout, and pressing a different combination of buttons simultaneously, such as lock buttons 1146 and 1166 as well as contour button 1184, initiates the security lockout. Any such presses can be configured to include a press-and-hold. Visual indications, such as illuminated or flashing LEDs, and/or audible indications, such as chirp sound, can also be provided to indicate which, if any, lockouts have been activated.

When a patient lockout is selected, at 1206, the controller 302 ignores a subset of commands input at the occupant's control panel 122, such as bed movement commands, while permitting other commands, such as nurse call or bed lighting commands. For example, an attendant may have chosen, by pressing the lock button 1126, to lockout raising and lowering of the upper-body portion 105 of the patient support deck 104 via the occupant's control panel 122. However, the controller 302 still responds to all commands input at the attendant's control panel 120.

At 1208, any active patient lockout can be deselected by, for example, the attendant pressing the respective lockout button 1126, 1146, 1166. When all patient lockouts are deselected, the patient support resumes normal operation at 1202.

When the master lockout is selected, at 1210, the controller 302 ignores either a subset of commands or all commands input at the occupant's control panel 122 as well as a subset of commands input at the attendant's control panel 120. In one embodiment, the subset of commands at the attendant's control panel 120 includes all commands except the emergency CPR function activated by the emergency CPR button 1182. That is, the patient support 100 cannot have its height adjusted nor its patient support deck 104 articulated with the exception of flattening the patient support deck 104 by pressing the emergency CPR button 1182. In the master lockout mode, other non-movement related buttons can be configured to still remain active, such as a nurse call button and bed light button. The master lockout can be used to prevent patients, visitors, or other unauthorized people from adjusting the patient support 100 in a way that may be detrimental to the patient.

At 1212, the master lockout can be deselected by, for example, again pressing all three lock buttons 1126, 1146, 1166 simultaneously.

When the security lockout is selected, at 1214, the controller 302 awaits input of a numeric access code. This is to prevent inadvertent or unauthorized activation of the security lockout. The access code is preselected, normally is not customizable by the end user of the patient support 100. The access code may comprise a series of digits (e.g., “161833”) that are entered at the attendant's control panel 120 by pressing the buttons 1122-1166. Accordingly, after the security lockout has been selected at step 1204, the controller 302 at step 1214 awaits entry of the access code at the buttons 1122-1166 instead of initiating the normal movement or lockout functions of the buttons 1122-1166. If the access code is not entered correctly or not entered within a predetermined timeout, then normal operation resumes at 1202.

If the access code is entered successfully, then, at step 1216, the controller 302 awaits selection of an authorization code via the buttons 1122-1166 of the attendant's control panel 120. Again, the controller 302 interprets presses of the buttons 1122-1166 as the associated digit and does not initiate the normal movement or lockout functions of the buttons 1122-1166. The attendant can enter any numeric code desired (e.g., “1369”) within predefined limits, such as one to six digits. The attendant should remember the numeric code selected, since this will be required to temporarily activate the attendant's control panel 120 during the security lockout.

During either or both of steps 1214 and 1216, numeric code entry can be aborted by again simultaneously pressing lock buttons 1146 and 1166 as well as contour button 1184 or by expiry of a timeout (e.g., 30 seconds) between button presses.

At 1218, the security lockout is fully activated. Accordingly, the controller 302 ignores all commands input at the occupant's control panel 122 as well as all commands input at the attendant's control panel 120, including presses of the emergency CPR button 1182. The patient support 100 cannot be raised, lowered, articulated, caused to flatten in the electronic CPR mode, or controlled in any other way. This advantageously prevents patients from hurting themselves or others with the patient support 100.

During security lockout, the controller 302, at 1220, checks for a simultaneous press of the lock buttons 1146 and 1166 as well as contour button 1184 followed by entry of the access code. When this condition is met, the controller 302 returns to normal operation at 1202. This allows the attendant to deactivate the security lockout.

Also during the security lockout, the controller 302, at 1222, checks for entry of the authorization code via the attendant's control panel 120. Because the controller 302 ignores movement commands during the security lockout, the controller 302 can interpret all presses of the buttons 1122-1166 as digits. Upon detecting entry of the authorization code, the controller 302, at 1224, temporarily responds to commands. In this embodiment, if the authorization code is entered incorrectly, no feedback is provided, which can assist in keeping the existence of enterable numeric codes secret from patients or other unauthorized individuals.

At step 1224, the controller 302 interprets movement function button presses at the attendant's control panel 120 and occupant's control panel 122 normally and as in the same manner as in step 1202. The attendant can thus control the patient support 100 to raise, lower, and articulate the patient support deck 104, as well as control other features. The patient support 100 also responds to a press of the emergency CPR button 1182. In this embodiment, the controller 302 also responds to commands via the occupant's control panel 122. In another embodiment, the controller 302 responds to commands at the attendant's control panel 120 and only outward facing control panels on the side rails 110. In still another embodiment, the controller 302 responds to commands only at the attendant's control panel 120.

While temporarily responding to commands at step 1224, the controller 302, at 1226, checks for a relock condition which, when met, returns the controller 302 to the state of ignoring commands at 1218 to disable functionality of the patient support 100. The relock condition can include one or more of an expiry of a timeout between button presses and entry of a relocking command. The timeout can be a predefined time, e.g., 30 seconds, without any button presses at one or more of the control panels 120, 122. This allows the return to step 1218 in the case where, for example, the attendant walks away from the patient support 100 after inputting commands. The relocking command can include the press of any of the lock buttons 1126, 1146, 1166. This allows the return to step 1218 in the case where, for example, the attendant desires to quickly restrict functionally of the patient support 100 without relying on a timeout.

In this embodiment of the method 1200, at any of the steps above where the controller 302 successfully receives input of a numeric code at the attendant's control panel 120, an audible and/or visible confirmation may be issued to provide feedback to the attendant indicating that the numeric entry was successful. Similarly, audible and/or visible prompts may be issued to provide feedback to the attendant indicating that numeric entry is expected. In another embodiment, no such confirmation or prompt is issued as a precaution against inadvertently alerting a patient or other unauthorized person that such codes can be entered.

The simultaneous button combinations described above are examples only. In other embodiments, other simultaneous button combinations, a single button press, or another input can be used to enter or exit any of the patient lockout, master lockout or security lockout.

In this embodiment of the method 1200, during entry of authorization codes and/or access codes, the controller 302 continually monitors for a sequence of button presses. A buffer that discards the oldest digit upon a new button press can be used. Accordingly, if a mistake is made, the attendant need only begin reentry of the code without having to first press a cancellation button.

Referring again to FIG. 13, in one embodiment, the controller 302, by way of the program 310, is configured to detect one or more authorization keys 1304 being provided to the access control device 1302 as a condition for enabling or disabling functionality of the patient support 100. For example, in order to enter a security lockout or temporarily disable a security lockout, it may be necessary to provide both a physical key and an authorization code, or any other combination of authorization keys 1304. In another embodiment, referring to steps 1204 and 1214 of FIG. 12, unlocking of the access control device 1302 by, for example, a physical key can cause the controller 302 to progress from step 1204 to step 1214 and await entry of the numeric access code (i.e., the physical key replaces or complements the simultaneous press of the lock buttons 1146 and 1166 as well as contour button 1184). Alternatively, the unlocking of the access control device 1302 by a physical key can cause the controller 302 to progress from step 1204 to step 1216 and directly enter the security lockout mode (i.e., the physical key replaces the simultaneous press of buttons 1146, 1166, 1184 and the manual entry of the access code). The same applies to step 1220, in which the access control device 1302 can be used in a similar manner to deactivate the security lockout.

In another embodiment, unlocking the access control device 1302 with a certain type of authorization key 1304, for example a physical key, replaces entry of the numeric authorization code at step 1222, and step 1216 is omitted. The access code is still required to activate the security lockout, but to temporarily control the functionality of the patient support 100, at step 1224, the selected type of authorization key 1304 is required instead of the authorization code.

The access control device 1302 may thus be configured to add an additional level of security for control of functionality of the patient support 100. That is, in addition to correctly inputting the authorization code and/or the access code, the attendant must also possess the an additional authorization key 1304. This can further improve patient safety and reduce the risk of harm or damage.

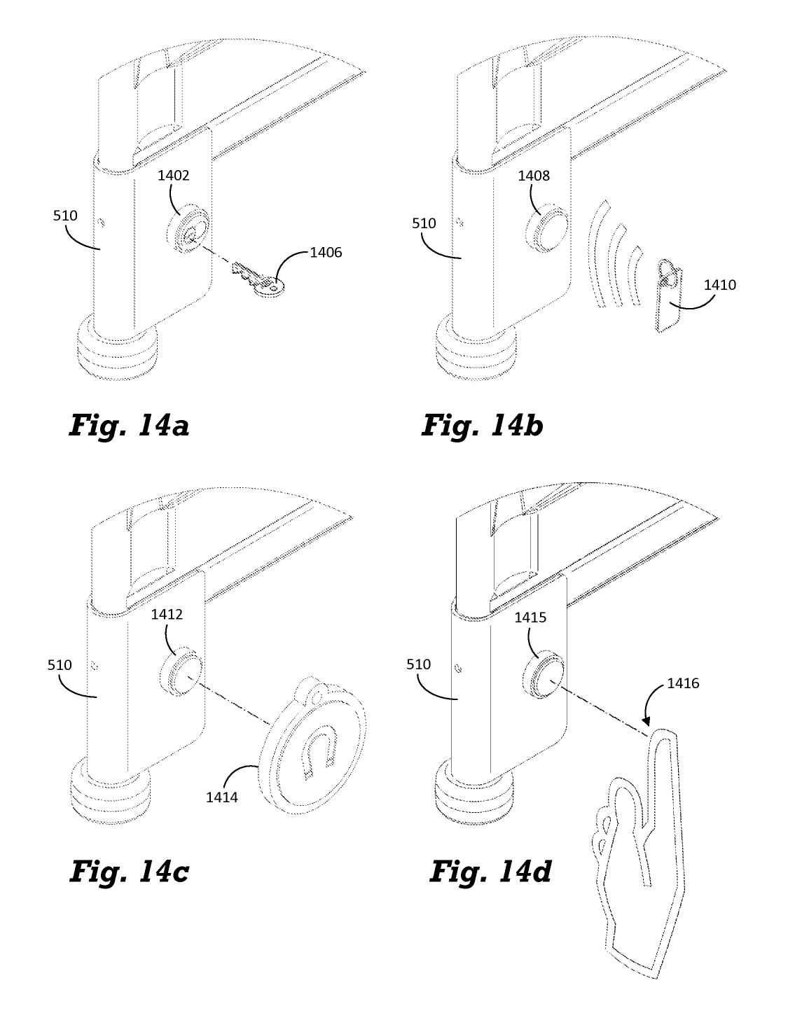

Referring to FIG. 5, the access control device 1302 can be located, for example, on a side bracket 510 to which the footboard 108 is attached. FIGS. 14a-c show a portion of the side bracket 510 from behind illustrating various embodiments for the access control device 1302 and authorization key 1304.

In one embodiment, referring to FIG. 14a, the access control device 1302 comprises a mechanical tumbler lock 1402 and a connected electrical limit switch 1404 that detects an unlocked position of the tumbler lock 1402 via movement of a portion of the tumbler lock 1402. The electrical limit switch 1404 is electrically connected to the controller 302 via wires (not shown). The authorization key 1304 is thus a physical key 1406, for example a metal key. The tumbler lock 1402 may be biased to the locked position, so that when the physical key 1406 is released, the tumbler lock 1402 automatically locks. This feature can replace or complement the use of timeouts in the method 1200 with respect to a numeric code or codes replaced by the tumbler lock 1402, since functionality can automatically be restricted when the physical key 1406 is not being turned by the attendant to hold the lock 1402 open.

In another embodiment, referring to FIG. 14b, the access control device 1302 comprises a radio-frequency device 1408 electrically connected to the controller 302 and the authorization key 1304 comprises a radio-frequency identification (RFID) tag 1410. The controller 302 is configured to activate functionality when the RFID tag 1410 is brought into an effective range of the radio-frequency device 1408. The controller 302 can also be configured to deactivate functionality when the RFID tag 1410 is again brought into the effective range of the radio-frequency device 1408, and a timeout may alternatively or additionally be used for this purpose.

In another embodiment, referring to FIG. 14c, the access control device 1302 comprises a magnet detector 1412, such as a Hall effect sensor or reed switch, and the authorization key 1304 comprises a magnet 1414. This may be in the form of a magnetic key card as is normally used to control access to doorway opening in restricted areas of a healthcare facility. Operation is similar to the RFID tag embodiment of FIG. 14b.

In another embodiment, referring to FIG. 14d, the access control device 1302 comprises a biometric interface 1415, such as fingerprint reader, a retinal scanner, or a voice recognition device, and the authorization key 1304 comprises a biometric trait of an authorized user, such as a fingerprint 1416. Operation is similar to the RFID tag embodiment of FIG. 14b.

Referring again to FIG. 5, the patient support 100 includes a brake pedal 512 for activating and deactivating a brake mechanism that is operatively coupled to at least one of the caster wheels 502, so as to selectively lock the caster wheel 502 and thus selectively immobilize the patient support 100. It may be desirable for an attendant to immobilize the patient support 100 in this manner at times. However, it is also desirable to prevent unauthorized people, such as a patient whose mental health is of concern, from deactivating the brake mechanism and moving the patient support 100, as this may result in harm to the patient or others or may cause damage to the patient support 100 or the facility.

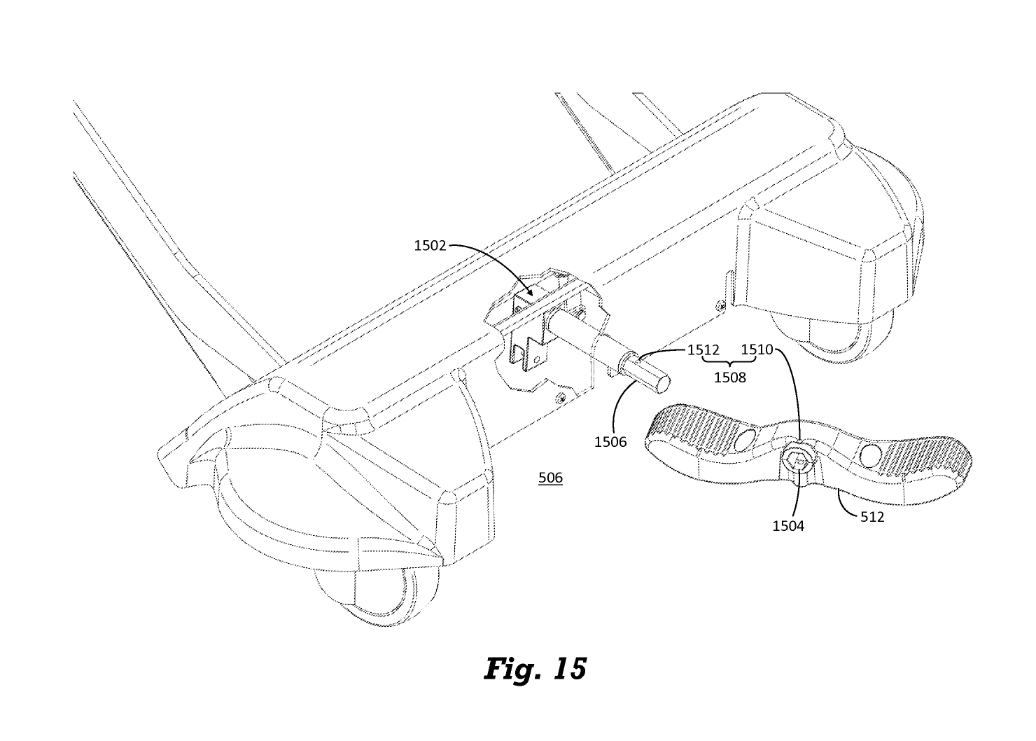

Accordingly, with reference to FIG. 15, the brake pedal 512 is removable from the brake mechanism 1502 by an attendant without the use of tools. In this embodiment, the brake pedal 512 has a non-circular (e.g., hexagonal) hole 1504 that mates with a like-shaped shaft 1506 of the brake mechanism 1502 to removably couple the brake pedal 512 to the brake mechanism 1502. The brake pedal 512 can thus be slid on and off the shaft 1506 and still allow for activation and deactivation of the brake mechanism 1502 when slid on.

The brake pedal 512 and shaft 1506 can also include an alignment indicator 1508. The alignment indicator 1508 can include separate indicators 1510, 1512, such as grooves, markings, holes, or similar, on each of the brake pedal 512 and shaft 1506 that visually indicate the correct orientation for the brake pedal 512. Alternatively, the alignment indicator 1508 can be mating surfaces on the shaft 1506 and hole 1504 of the brake pedal 512 that permit only one mating orientation of the shaft 1506 and hole 1504. Examples of such include non-symmetric shapes such as a generally circular shaft with a single flat face and a correspondingly shaped hole in the brake pedal 512.

In use, after pressing the brake pedal 512 into the position that activates the brake mechanism 1502 and immobilizes the patient support 100, the attendant can simply pull the brake pedal 512 off the shaft 1506. When the time comes to move the patient support 100, the attendant returns with the brake pedal 512 and slides it back onto the shaft 1506, referencing the alignment indicator 1508, before pressing the brake pedal 512 into the position that deactivates the brake mechanism 1502 and allows the patient support 100 to be rolled.

In another embodiment, the brake pedal 512 can have a shaft that mates with a hole in the brake mechanism 1502.

The patient support 100 includes additional safety features that can advantageously reduce the risk of injury or damage, particularly when used with patients whose mental condition is of concern.

Referring to FIG. 5, flexible retainers 514 are provided at hinges 516, 518 of the panels 520, 522, 524 of the patient support deck 104. Since one or more of the panels 520, 522, 524 may not be fastened to the frame 102 and may have a hinge that is readily breakable or designed to be separable without tools, the flexible retainers 514 can prevent the panels 520, 522, 524 of the patient support deck 104 from being taken apart easily. Typically, the panel 522 under the patient's mid-section is fastened to the frame 102, while the panels 520, 524 positioned under the patient's head and feet are hinged to permit articulation and thus may not be fastened securely enough to the frame 102 or mid-section panel 522 to prevent unauthorized removal. By providing the flexible retainers 514, the risk of a patient removing a panel and causing harm or damage is reduced, while still allowing the hinges 516, 518 to function unimpeded. Any number of flexible retainers 514 may be used at each of the hinges 516, 518.

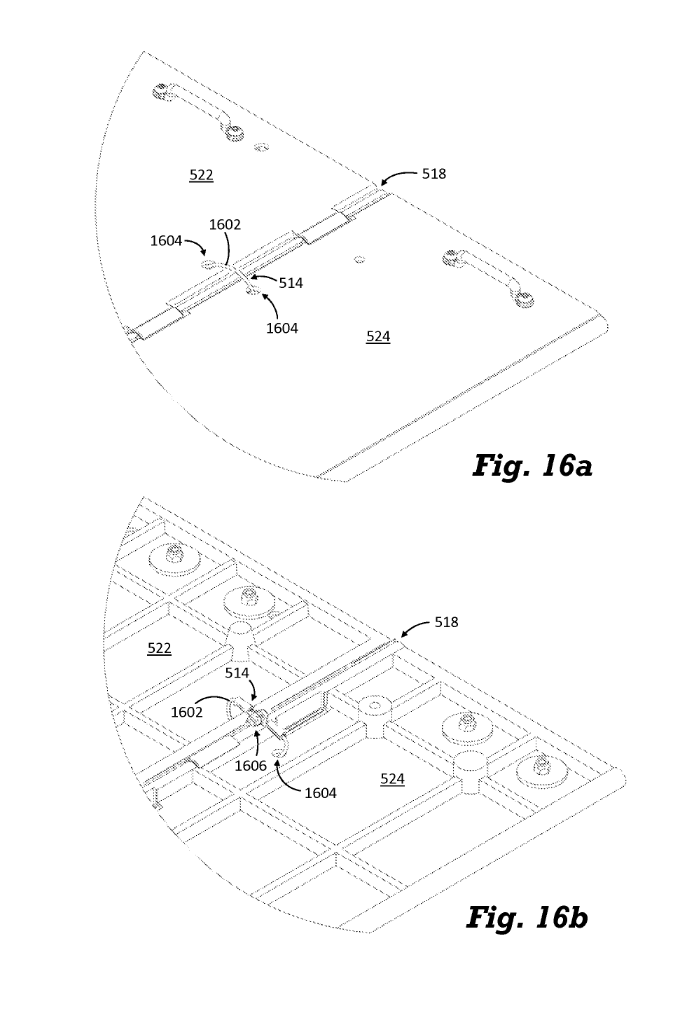

As shown in FIG. 16a, one flexible retainer 514 is shown from above positioned at the separable hinge 518 between the mid-section panel 522, which is fixed to the frame 102, and the foot panel 524, which is not fixed to the frame 102. It can be seen that, in this embodiment, the flexible retainer 514 is a cable loop 1602 that loops through holes 1604 in the panels 522, 524 and has ends with eyelets joined by a removable fastener 1606, such as a bolt with a locknut, as shown in FIG. 16b. The removable fastener 1606 allows removal of the flexible retainer 514, and thus separation of connected panels 522, 524, with tools for maintenance purposes, while reducing the risk of unauthorized removal and allowing the hinge 518 to function as expected.

Referring to FIG. 5, in this embodiment, the headboard 106 and footboard 108 are non-removably fixed to the frame 102. This can advantageously prevent unauthorized removal of the headboard 106 and footboard 108 to reduce the chance of patients harming themselves or others or damaging property. In this embodiment, bolts 526 (one shown removed) thread into vertical posts 528 of the footboard 108. Heads of the bolts 526 abut underside portions of the frame 102 to securely hold the footboard 108 in place and prevent removal of the footboard 108 without tools. The same structure is used at the headboard 106.

Still referring to FIG. 5, due to the need to occasionally restrain patients, patient restraint loops 532 are provided on opposite sides of the patient support deck 104. The restraint loops 532 are positioned in pairs opposite each other to receive and hold adjustable patient restraints across the patient's body. Any number of restraint loops 532 can be provided along the length of the support deck 104. It is advantageous that the restraint loops 532 are provided on the support deck 104 because the support deck 104 can still be raised, lowered, and articulated to at least some degree without unduly tightening or loosening the restraints.

With reference to FIG. 5, a power cord 534 is provided to supply power to the patient support 100 from, for example, an electrical outlet. The power cord 534 provides power to the controller 302 (FIG. 3), actuators 200 (FIG. 2), as well as any other components that require it. The power cord 534 extends from the patient support 100 by an exposed length selected to reduce a strangulation hazard, while still remaining long enough to be practical to use. This can advantageously improve patient safety. In this embodiment, the power cord 534 extends from the lower end of the head-end leg assembly 112, and more particularly, from the attached caster assembly 118. The exposed length of the power cord 534 is kept as short as practical, which is facilitated by having the power cord 534 begin its exposed length near the floor 506 to place it at or near the approximate elevation of typical wall or floor outlets. In one example, the exposed length of the power cord 534 is about 3 feet (or 91 cm) or shorter. The remaining length of the power cord 534, that is, the length running from the caster assembly 118 to an electrical component (e.g., the controller 302, a battery, or onboard power supply) of the patient support 100, can be concealed by components of the patient support 100, such as panels, covers, or housings of the caster assembly 118 and leg assembly 112.

To reduce the risk that a patient or other unauthorized person may attempt to remove components from the patient support 100 to cause harm or damage, the patient support 100 is assembled with tamper-resistant fasteners connecting many or all of the components together. Such components can include the frame 102, patient support deck 104, headboard 106 and footboard 108, side rails 110, caster wheels 502 and caster assemblies 118, leg assemblies 112, 114, restraint loops 532, deck panel retainers 514, and floor securing devices 508, among others. Suitable tamper-resistant fasteners include bolts or studs with locknuts, such as nylon insert locknuts, which are available under the trade-name Nyloc™. An example of such a tamper-resistant fastener is shown at 1606 in FIG. 16b.

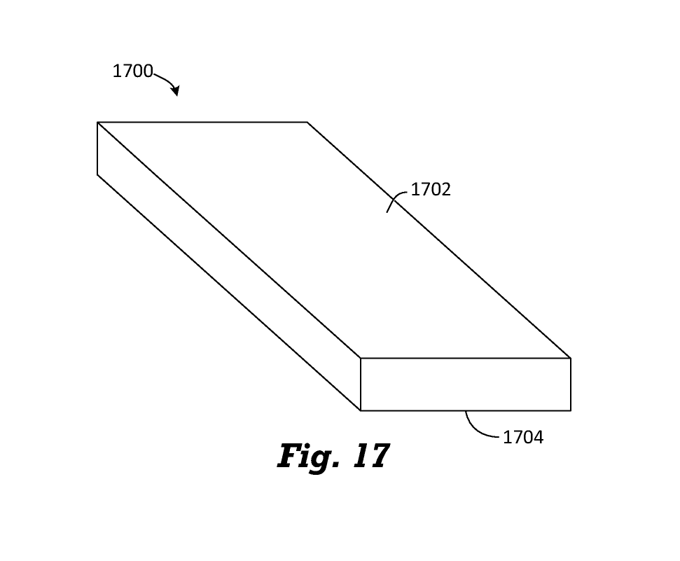

With reference to FIG. 17, the patient support 100 can include a mattress 1700 sized and shaped to be disposed on the patient support deck 104. The mattress 1700 can include a zipper-less cover 1702. Such a cover 1702 can be made by sewing all seams. The cover 1702 can be made by, for example, cutting a piece of fabric to shape and then sewing together all seams except one. The cover 1702 is then turned inside-out to hide the sewed seams, a foam or other mattress body is inserted into the cover 1702 at the unsewn seam 1704, which is then sewed shut from the outside. The majority of seams of the mattress are thus tamper-resistant by virtue of their location on the inside of the cover 1702. The mattress cover 1702 lacking a zipper advantageously prevents mental health patients from opening or removing the cover and possibly causing harm to themselves by using the mattress cover as a strangulation device, thereby improving patient safety.

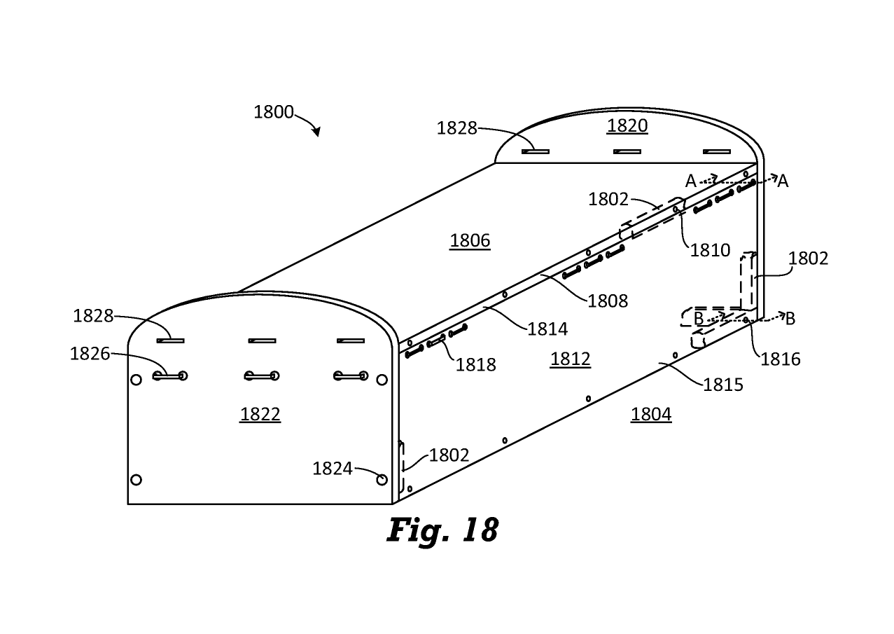

With reference to FIG. 18, another embodiment of a patient support 1800 with safety features for use in applications where the patient's mental condition is of concern will now be discussed. Features and aspects of the patient support 1800 can be used with the patient supports of the other embodiments described herein and vice versa.

The patient support 1800 includes a frame 1802 configured to be supported by the floor 1804. The frame 1802 has a generally rectangular shape and is made of steel (or other metal) box tubing. The frame 1802 can include twelve or more lengths of box tubing arranged at the twelve edges of a rectangular prism. The frame 1802 is only partially shown in FIG. 18 in hidden line for the sake of clarity.

The patient support 1800 further includes a generally rectangular, flat non-articulating patient support deck 1806 supported by the top of the frame 1802. In this embodiment, the patient support deck 1806 is made from a single piece of sheet metal, such as 10 gauge steel sheet. An antimicrobial material, such as paint or coating containing silver, can be applied to the patient support deck 1806. The patient support deck 1806 has side edges 1808 (one hidden) that are bent downwards and fixed to the outside of the frame 1802 by fasteners 1810.

The patient support 1800 further includes generally rectangular and flat side panels 1812 (one hidden). Top edges 1814 of the side panels 1812 are overlapped by the downwardly bent side edges 1808 of the patient support deck 1806, and accordingly, the top edges 1814 of the side panels 1812 are fixed to the frame 1802 by the same fasteners 1810 that fix the patient support deck 1806 to the frame 1802. The side panels 1812 extend from the patient support deck 1806 to the floor 1804 to partially enclose a space below the patient support deck 1806. Bottom edges 1815 of the side panels 1812 are also fixed to the frame by fasteners 1816. The side panels 1812 can be made of plastic, such as high-density polyethylene (HDPE), and may be provided with antimicrobial material, such as embedded additives or a silver-bearing paint or coating.

The patient support 1800 further includes patient restraint loops 1818 positioned on opposite sides of the patient support deck 1806. In this embodiment, the restraint loops 1818 are fixed to the side panels 1812 by fasteners. The restraint loops 1818 are provided in pairs, one on each side panel 1812, and any number of restraint loop pairs can be provided. Restraint loops on the far side are hidden in the figure. In this embodiment, three groups of restraint loop pairs are positioned at the head, mid-section, and foot of the patient support deck 1806.

The patient support 1800 further includes a non-removable headboard 1820 fixed to the frame 1802 and a non-removable footboard 1822 fixed to the frame 1802. Fasteners are used to fix the headboard 1820 and footboard 1822 to the frame 1802, and such fasteners can be concealed by tamper-resistant plugs, at 1824. The headboard 1820 and footboard 1822 can be made of plastic, such as HDPE, and may be provided with antimicrobial material, such as embedded additives or silver-bearing paint or coating. With the support deck 1806 and side panels 1812, the headboard 1820 and footboard 1822 complete the enclosed box-like structure of the patient support 1800.

Additional, longitudinally aligned restraint loops 1826 may be positioned on the outside faces of the headboard 1820 and footboard 1822, and the headboard 1820 and footboard 1822 may be provided with slots 1828 at locations above the restraint loops 1826 to guide longitudinally aligned restraints. In FIG. 18, while only the longitudinally aligned restraint loops 1826 on the footboard 1822 are visible, the longitudinally aligned restraint loops 1826 on the headboard 1820 are similar or identical. In this embodiment, three pairs of longitudinally aligned restraint loops 1826 and slots 1828 are provided.

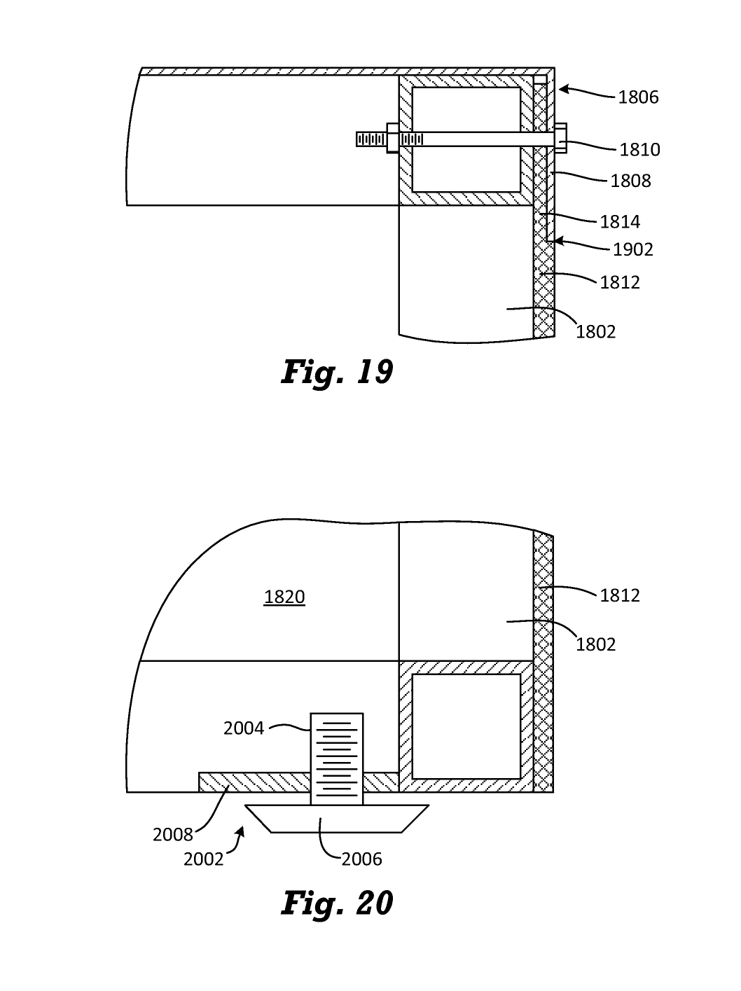

FIG. 19 shows a detail of the patient support 1800 of FIG. 18 sectioned at A-A. A portion of the tubular box frame 1802 is shown. As can be seen, the side edge 1808 of the patient support deck 1806 overlaps the top edge 1814 of the side panel 1812. The top edge 1814 of the side panel 1812 is made thinner than the bulk of the side panel 1812, so as to allow the overlapping side edge 1808 of the patient support deck 1806 to be flush with the exposed portion of the side panel 1812, at 1902. The flush joint 1902 eliminates a potentially sharp edge that could be used by a mental health patient to cause bodily harm. Also shown is one of the fasteners 1810, which in this embodiment is a bolt with a locknut, the bolt penetrating all of the frame 102, the top edge 1814 of the side panel 1812, and the side edge 1808 of the patient support deck 1806.

FIG. 20 shows a detail of the patient support 1800 of FIG. 18 sectioned at B-B. The patient support 1800 includes four height-adjustable feet 2002 (one shown) attached to the bottom four corners of the frame 1802 for adjustably supporting the patient support 1800 on the floor 1804. Accordingly, the frame 1802 can be considered a height-adjustable frame.

In this embodiment, each height-adjustable foot 2002 includes a threaded stud 2004 and an attached plastic or rubber foot piece 2006. The stud 2004 threads into a bracket 2008 that is welded or otherwise attached to the inside of an lower corner of the frame 1802. By rotating the height-adjustable foot 2002, the stud 2004 travels up or down to adjust the distance the foot piece 2006 extends from the patient support 1800.

The fasteners connecting the components of the patient support 1800 together can be tamper-resistant fasteners. Such components can include the frame 1802, patient support deck 1806, side panels 1812, and restraint loops 1818, 1826, among others. Suitable tamper-resistant fasteners include bolts or studs with locknuts, such as nylon insert locknuts, which are available under the trade-name Nyloc™. An example of such a tamper-resistant fastener is shown at 1810 in FIG. 19.

The metal components of the patient support 1800, such as the frame 1802 and patient support deck 1806 may be painted.

While the foregoing provides certain non-limiting example embodiments, it should be understood that combinations, subsets, and variations of the foregoing are contemplated. The monopoly sought is defined by the claims.

What is claimed is:

1. A patient support comprising:
a frame;
a patient support deck coupled to the frame and configured to support a patient;
wheels coupled to the frame and positioned to movably support the frame on a floor; and,
a securing device coupled to the frame, the securing device configured to releasably secure the patient support to a location suitable for immobilizing the patient support.

2. The patient support of claim 1, wherein the securing device is configured to removably fasten the frame to the floor.

3. The patient support of claim 1, wherein the securing device comprises at least one connecting member and a base from which the connecting member extends, the connecting member having one end connected to the base and another end removably fastened to the frame, the base configured to be fixed to the floor.

4. The patient support of claim 3, wherein the connecting member is pivotally connected to the base.

5. The patient support of claim 3, wherein the connecting member is removable from the base.

6. The patient support of claim 1, wherein the frame comprises a leg assembly and a connected caster assembly, the securing device being fastened to the caster assembly.

7. The patient support of claim 6, wherein the securing device is positioned under a portion of the caster assembly.

8. A patient support comprising:
a frame comprising at least a height-adjustable frame portion;
a patient support deck coupled to the height-adjustable frame portion and configured to support a patient;
wheels coupled to the frame and positioned to movably support the frame on a floor;
a control panel coupled to the frame and positioned to be accessed by an attendant; and,
a controller coupled to the control panel and configured to control functionality of the patient support comprising at least one of articulation of the patient support deck or height adjustment of the height-adjustable frame portion, the controller configured to enable the functionality when an access control device coupled to the controller is unlocked.

9. The patient support of claim 8, wherein the control panel comprises the access control device.

10. The patient support of claim 8, wherein the access control device is unlocked by an authorization code, the control panel comprises a plurality of buttons, at least one of which is labeled for controlling functionality of the bed other than the access control device and wherein the authorization code corresponds to a pattern of the buttons.

11. The patient support of claim 8, wherein the controller is configured to temporarily enable the functionality of the patient support in response to the access control device being unlocked.

12. The patient support of claim 11, wherein the controller is configured to disable the functionality after expiry of a timeout.

13. The patient support of claim 8, wherein the patient support comprises an emergency mechanism configured to provide movement of the patient support deck in the event of a need for cardiopulmonary resuscitation of the patient that is enabled irrespective of the access control device.

14. The patient support of claim 8, wherein the controller is configured to disable the functionality of the patient support when the access control device is locked.

15. A patient support comprising:
a frame configured to be supported by a floor;
a non-articulating patient support deck supported by the frame;
at least two side panels extending from the patient support deck to the floor to enclose a space below the patient support deck, each side panel having a top edge and a bottom edge; and,
restraint loops on opposite sides of the patient support deck.

16. The patient support of claim 15, wherein the restraint loops are fixed to the side panels.

17. The patient support of claim 15, wherein the top edge of each side panel is fixed to the frame and the bottom edge of each side panel is fixed to the frame.

18. The patient support of claim 15, wherein the patient support deck comprises a side edge that is bent downwards and fixed to an outside of the frame.

19. The patient support of claim 15, wherein the patient support deck comprises a side edge that overlaps or abuts the top edge of each side panel.

20. The patient support of claim 15, further comprising tamper-resistant fasteners connecting the frame with the patient support deck, the side panel, and/or the restraint loops.
